(19) United States
(12) Patent Application Publication
(10) Pub. No.: US 2010/0191691 A1
(43) Pub. Date: Jul. 29, 2010

(54) Method for computer-aided decision-making system and method that utilizes product, services and/or venue values and personality value matching, incorporating groups and outside values

(76) Inventor: James Thomas Hudson, JR., Grapevine, TX (US)

Correspondence Address: James T. Hudson Jr., 2834 Southridge Dr., Grapevine, TX, 76051, US

(21) Appl. No.: 12/616,639

(22) Filed: Nov. 11, 2009

Related U.S. Application Data
(60) Provisional application No. 61/146,721, filed on Jan. 23, 2009.

(51) Int. Cl. G06N 5/02; G06F 17/00; G06Q 10/00; G06Q 50/00

(52) U.S. Cl. 706/47; 705/10; 706/50

(57) ABSTRACT

A computer-aided decision-making system and method that is applicable to a variety of applications such as, but not limited to, Booking and Reservations systems or Automated Real Estate services or Broker Monitoring systems. The computer-aided decision-making system provides immediate, useful, and relevant information to a person in a decision-making context, overcoming problems that do not allow one to see all the possibilities while making decisions, and enabling consumer purchases, or management guidance, in an on-line sales environment. This system is also able to quantify the concept of “Fun, Risk or other Human concepts” that were otherwise unable to be quantified earlier. The system allows for the creation and evaluation of individuals and groups as well as the incorporation of outside values/standards, as opposed to just internal values/standards, that may have an application to the Product, Service or Venue.

### TECHNICAL FIELD

The present invention relates to providing system proactively to web applications. This happens through the use of separate databases and interaction of with the client. One database is used to temporarily store information about the client's wants, needs and desires, thus creating the client's OV and the other database is used to store information about the value matrix of different venues located at different sites and locales or the different services and products that a company wants to offer.

### BACKGROUND

The expansion of the Internet and the World Wide Web has allowed goods and services to be projected to the word at large. There is no one in the industrialized world that does not know of, and few have not used, the Internet. Having reviewed the current state of user applications there is no system that is truly proactive in meeting the client's needs, wants or desires. At this time the client needs to know what he/she wants, and then needs to locate a web site that then offers the service/product/venue. Using this system, a client has a greater probability of selecting solutions that the client will have a good experience (enjoy.) Even when the provider is tapped into the client's purchasing database, the current state of affairs has providers providing advertising or offerings to their clients that may or may not relate to what the client truly wants or needs.

This system is similar to the date matching systems in use today in that we do utilize a basic personality study but there are 2 major differences between current date matching systems and this system, this system goes beyond matching just individuals and can be applied to groups and this system is applied to products, services and venues to the client instead of an individual client to an individual client. Thus this patent can allow new techniques such as reverse data-mining, where the product, service or venues are data-mined for application to a clients need, want or desire as opposed to the client's financial information being data-mined for a possible application of a product, service or venue. Reverse data-mining reduces costs to the providers, and thus to the providers clients in the long run.

This system allows the provider to identify the information that the client is interested in and respond with suitable offerings. Using travel systems as an example, current booking and travel web sites still require the client to know where they want to go. There is no method available to help the client know where it is that they want to go. This is normally a function of a traditional Travel Agent.

There is no true automated travel agent system, just booking and reservations systems with lots of advertising. Using the current tools available to the travel systems today, and this process, an automated travel agent is now possible. With this tool an Automated Banking/Investment system can be proactive with their client's wants and desires and make the appropriate offering to the client, conversely the brokerage houses can utilize this process to make sure that their clients are not being offered investment tools that are contrary to their goals and objectives.

The following paragraph is a brief history of the Airline booking industry to show an example of why this system is needed. Currently the airline industry is in the 5^{th} generation of system availability. 1^{st} generation was a filing system that was limited to 8 agents. 2^{nd} generation was the movement of the filing system to electrical means; they still needed 2 people for each reservation. 3^{rd} generation was the automated systems development that eliminated the need for a back room person to the booking process. SABRE would be a good example of this. The 4^{th} generation allowed the expansion of the system out of the airlines into travel agencies. The 5^{th} generation was the final expansion into the interne that allowed the industry to reach the entire global population. An argument could be made that the addition of Data-mining is another generation advance, but that only affects marketing and not how the product is delivered to the clients. This is where the whole Booking and Reservations industry has been stuck for over 10 years.

Coupled with this is the inability for users and the providers to quantify the concept of “Fun or Risk,” and other descriptive but, thus far, non-quantifiable “values.” For example, each of us knows what “Fun or Risk” is. We can communicate to one another that something or some venue was “Fun or Risky.” Thus far the ability to quantify “Fun or Risk” and compare it to other “Fun or Risky” venues has not been successful across non-common venues. One can compare Roller Coasters to other Roller Coasters but how does one compare the Roller Coaster to a National Park? This system is capable of doing this for an individual, a family, a group or an organization. This ability to quantify “Fun or Risk,” in reference to the venue, is what allows the system to function with the Travel Booking system. Other systems that require objective judgment can now be quantified as well.

This process has the ability to incorporate outside value systems in order to provide a more balanced and current evaluation of products, goods, services and venues. This is important because human beings are dynamic in their likes and dislikes, definitions of Acceptable and Risky, etc. being able to reflect these into a computer program via this process allows a company to stay current with today's fast paced world and remove a programmer's bias.

The ability to go beyond individual profiling is also a huge assist to all industries. Travel agencies have always dealt with families but the process is capable of going beyond handling small groups. Being able to handle organizations or parts of organizations allows companies to be able to evaluate specific parts of themselves, to make sure that the company is capable of providing the best goods, products or services to their clients. Any company with a client facing organization will see this advantage.

This ability to self-evaluate a company's client facing group's personality profile means that a company will know what sort of personality it is projecting to their clients on a consistent basis. It will also allow a company to understand how the individual parts, or people, within the organization make up that personality. Should the company decide that they want a different projected persona, the company could then understand what parts or people they need to change out, or shuffle around, in order to get to the desired personality profile that their clients would interface with on a consistent basis.

The ability to do reverse data mining will be a major cost savings to companies. Current data mining systems follows a specific production path. This starts with a company developing a specific demographic/economic profile that is then compared to individual purchasing databases. This data then goes to the company so it can advertise its goods, products, services or venues to specific clients. The current focus of data mining is to evaluate the individual purchasing database to predict future trends or purchases. Reverse data mining allows for the evaluation of the good, product, service or venue for comparison with a client's actual desires, wants or needs. This reduces the costs required to be expended with the credit companies. Since a company can only justify the expenditure of monies to the credit companies for a specific demographic/s that means that they are self limiting their markets and that not all of a population can be addressed. With reverse data mining the focus is not on the individual purchaser but on the good, product, service or venue. This means that the company can address their offerings to the entire population that can be serviced instead of a smaller sub-grouping that might want their offering.

A look at previous art in this area filed shows a lack of ability to handle 3 things: Grouping, External controls and Reverse Data-Mining. This patent provides us with the ability to group both the personal profiles of multiple persons as well as the grouping of profiles/attributes of the Products, Services and Venues. This patent can also incorporate External Standards, this means that personal bias can be removed and the recognition that a product, service or venue is a real premium as opposed to just marketing or advertising. Reverse data-mining shows that it is now possible to focus on the products, services or venues for delivery of something desired instead of focusing on the financial information of persons that have no connection to your company. This ability allows us, society, to remove 1 more level of intrusiveness into each other's personal business and focus on the cost effective delivery of products, goods and services.

### SUMMARY

One objective of the present invention is to allow the travel booking industry to offer to their clients different options that were not available to them earlier, such as an automated Travel Agent. Another objective is to allow Real Estate business systems the ability to provide automated Real Estate tools that are more attuned to their client's needs. This invention also allows better focus of an advertiser's dollar. This invention allows clients a better choice of options that they may not have known about. This invention goes beyond the Travel Booking or Real Estate aspect. This invention allows better proactively for all web systems that require humans to decide what it is that they want based on characteristics of a merchant's product, service or venue. This could be used for creating web-based Brokers and other web-based applications where a human would normally be used to interpret the client's needs, wants and desires. The process also allows for the automation of risk checking tools for companies as well as the ability to reverse data mine.

### BRIEF DESCRIPTION OF THE DRAWINGS

FIG. 1A is the start of the user profile flow process that allows for the use of grouping profiles should more than one (1) profile be required to make a decision. Should there be multiple profiles that need to be included in making a decision there are processes for these. Included in this process is for peers; a system should there be a priority amongst profiles; a combination of the two for a small group or a family set of profiles; and an organizational system should the group of decision makers have a more complex social decision making makeup.

FIG. 1B this process is for handling peer groups. Where all the individuals are seen as equals in there needs, wants and desires.

FIG. 1C this process is the hierarchical weighted system when the client wants to assign decision priorities to the group.

FIG. 1D is the complex weighting system that is more reflective of a family situation where the parents would be seen as equal partners, and sibling groups would make up other sub-groups. These groupings could then be assigned a specific number according to their priority ranking by the client.

FIG. 1E this is the organizational modeling process. This is used for organizations that have different sub-organizations within the larger organization itself. Each sub-organization is modeled within a larger organizational structure. After the separate organizational blocks have been arranged to the client's satisfaction, the individual profiles are assigned to the separate blocks so that system can generate an individual profile for the organization as a whole.

FIG. 1F this is the sub-grouping process that is best used with families but can be used with any grouping process. The process generates sub-groups, specifically for families with children, but can be used for other groupings as well. Grandparents with children or small organizational get-togethers would be a good example. Note: If excessively large groupings were resolved earlier, resolving sub-groups may cause excessive resource usage. It is recommended that there are limits to the number of profiles that will be part of a sub-grouping process.

FIG. 1G this is a “Brute Force” method of dealing with this issue, where large amounts of computing power is used to develop a result. This is not a desired method and is used sparingly.

FIG. 1H this is the user profile completion process. After the client has made arrangements to determine the final user profile, the client has a chance to develop sub-groups; The user is provided the results of the possible matches with their profiles as well as venue matches for sub-groupings, is requested; The process also allows for exiting the process to go to other parts of the clients existing web site.

FIG. 1 this is a process that can be used to group profiles based from a web list.

FIG. 2 this drawing is used to help the reader understand the reasoning behind how the organizational profile should be developed. Blocks within blocks, with each block either a peer or hierarchical block.

FIG. 3A starts the evaluation process for a VPS system with the option of having the ability to incorporate an outside measurement system incorporated into the flowchart. The process requires the setting of standards to be used for every VPS. These standards reflect the basic values of the VPS type and not a ranking of the VPS itself.

FIG. 3B shows a Complex Locale/Venue Evaluation process for a VPS system using the set of standards generated in FIG. 3A for every VPS. It allows for the detailed evaluation of VPSs that are made separate objects that could be considered to be a separate VPS themselves according to the standards generated earlier. This is most often seen with larger venue offerings like an amusement/theme park but sometimes goods, products and services can be part of a package that would have separate constituent parts.

FIG. 3C this process is the Outside Standards Process. This process is called to when ever the need to the use of the outside measurement is needed. Note that the standards referenced for the outside standards process were generated in FIG. 3A.

Table 1 an example of a simple rating standard. (Note: The actual standards table is expected to be much larger. This table is only for demonstration purposes)

Table 2 an example of a Locale, called Town A, using the sample rating standard in Table 1

### DETAILED DESCRIPTION

The following description is of the best mode presently contemplated for practicing the invention. The description is not to be taken in a limiting sense, but is made merely for the purpose of describing the general principles and processes of the invention. The scope of the invention should be ascertained with reference to the issued claims. The focus of this example is on a travel booking system in order to provide a better way for this process to be evaluated in an actual usage situation. This example is to be used as an example only and not meant to limit the usage of this process to other industries or applications.

The Analysis engine is a set of software driven programs that allows one to compare different databases. One database would be the profile of the client and the other would be the profile of the product, service or venues. The best matches, or closest percentage match, would be presented to the client.

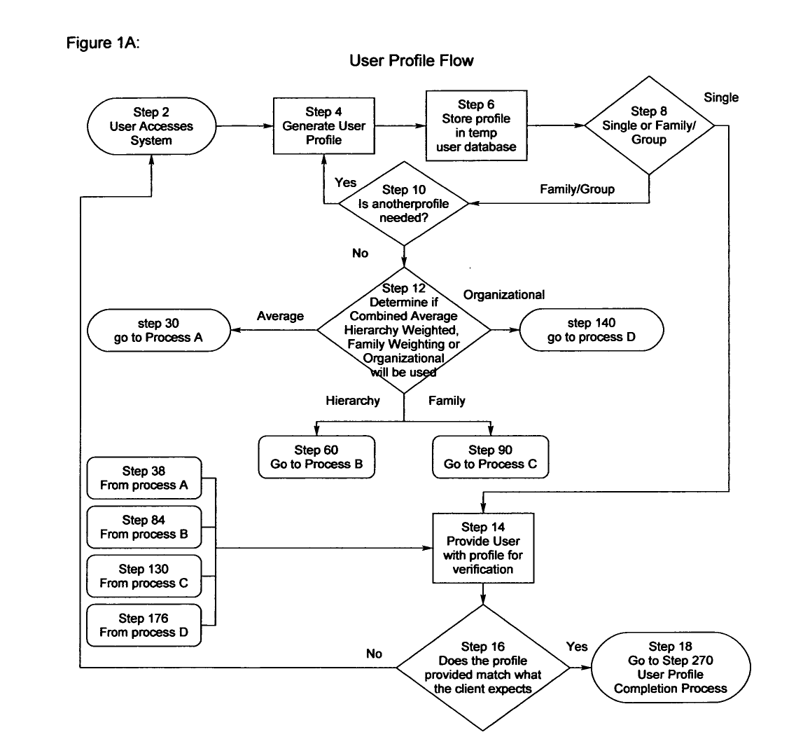

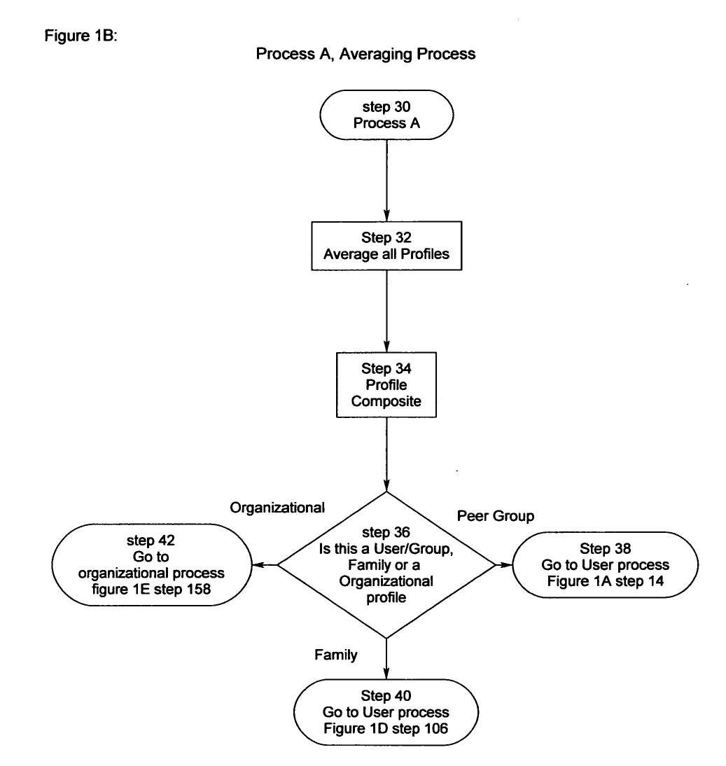

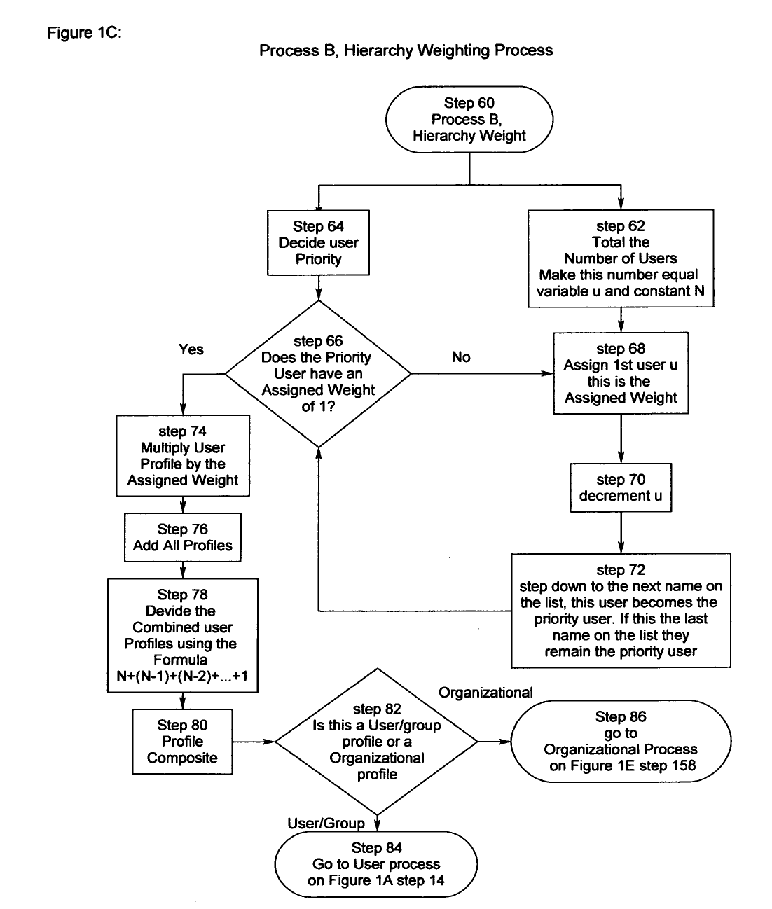

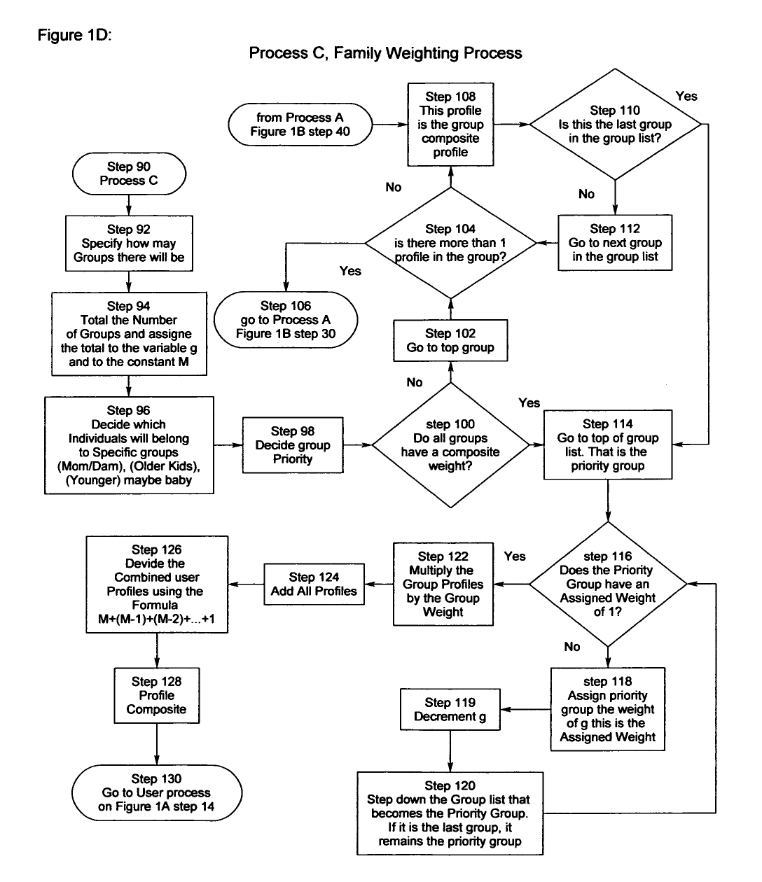

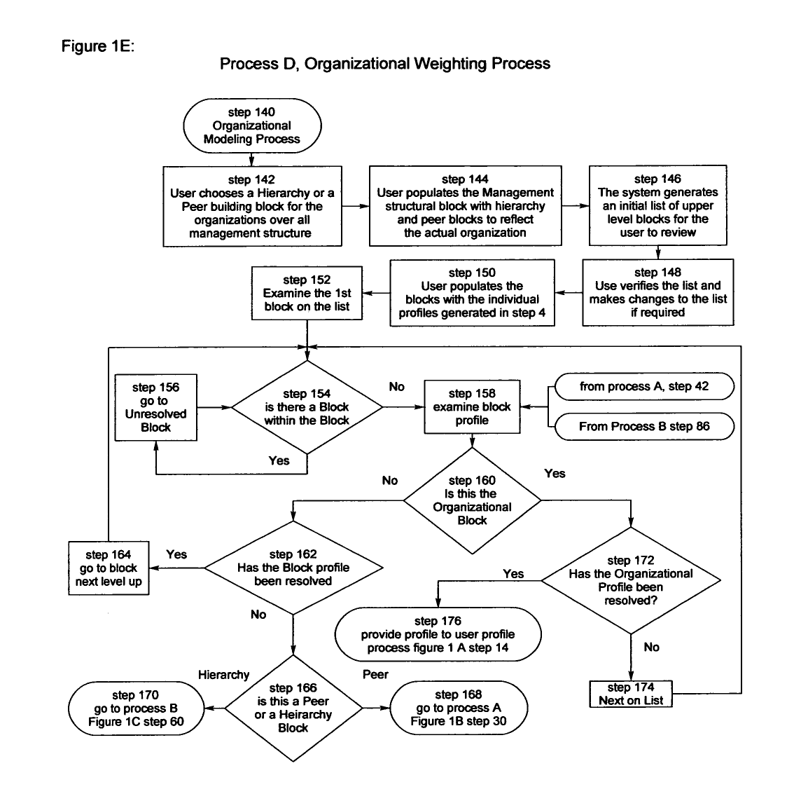

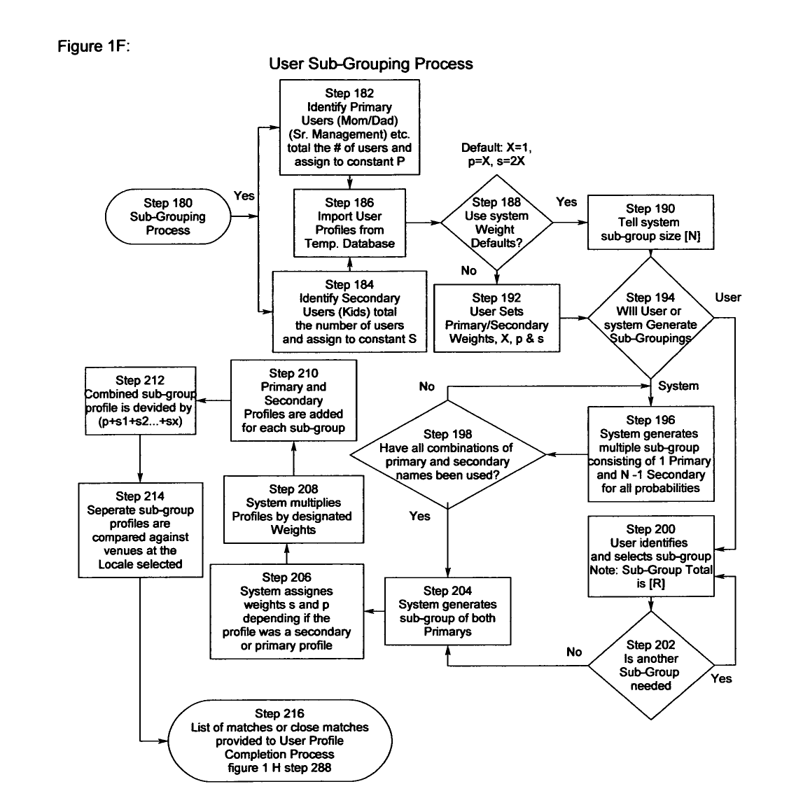

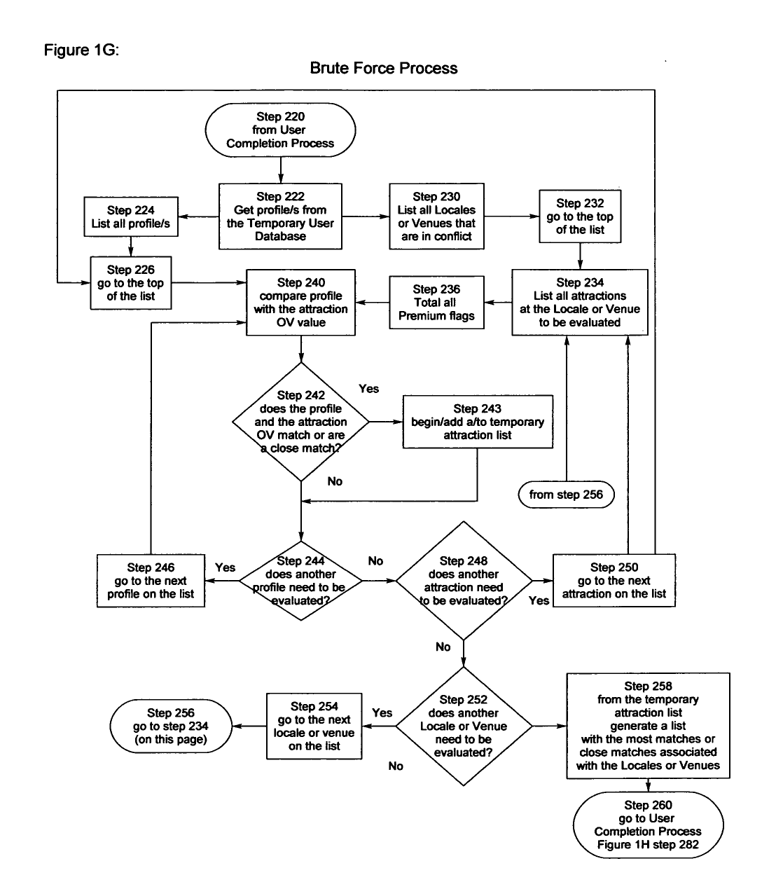

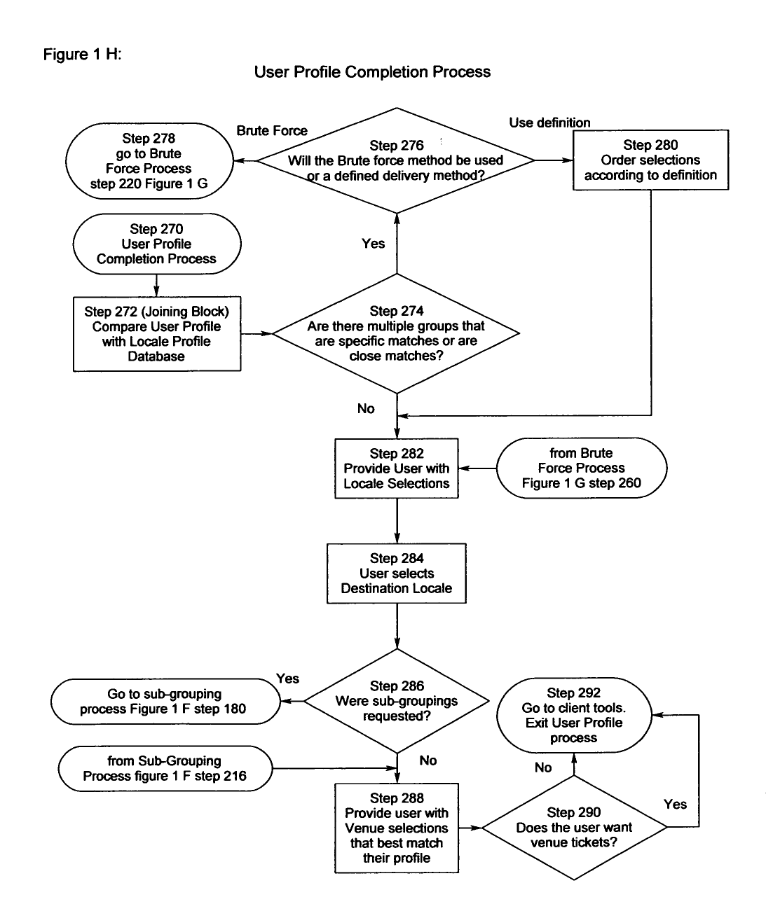

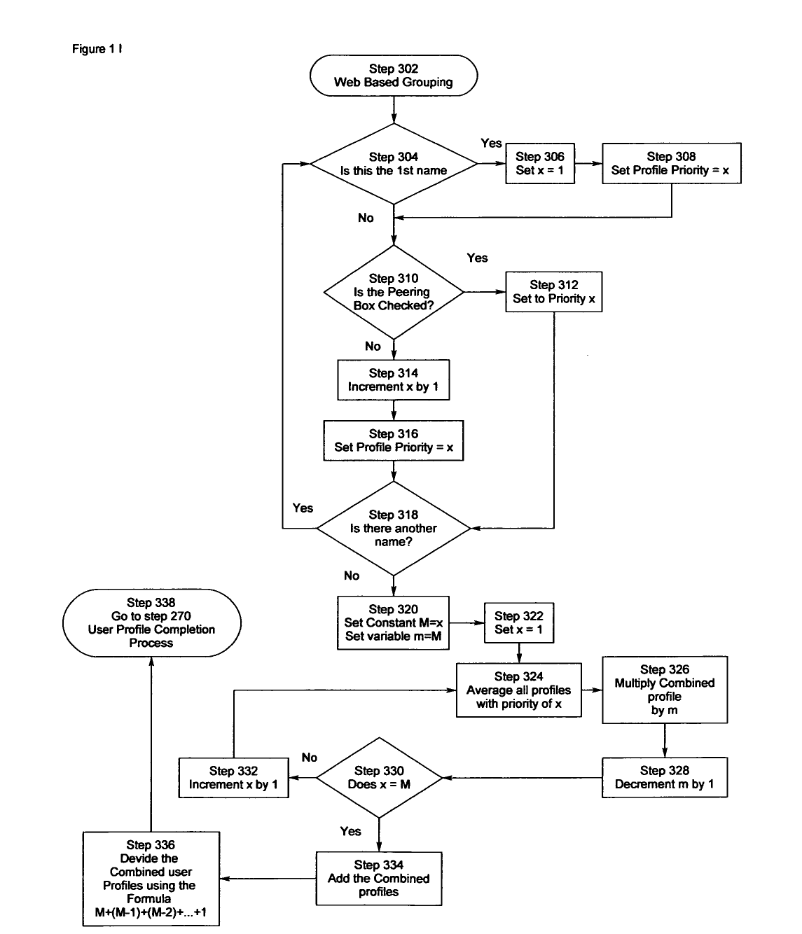

A client would access the system (see FIG. 1A). The system would prompt the client for specific client information that would determine the client's interests, a personality review. This makes up the client's profile and goes into the temporary client database.

The temporary client database would include different values that would best represent the client's preferences. Similar to the client profiles utilized by the computer dating services, this program determines the client's basic needs, wants and desires. It is a personality profile. Different values would be generated for the client for such things, but not limited to, as: is the individual Adventurous vs. Sedentary; Age: young vs. Old; Tactile vs. non-tactile; Participatory vs. Observation; Aggressive vs. Passive; Science vs. Art; Hazardous vs. Safety; Scary vs. Humorous; and Adult theme vs. Family Friendly; Public vs. Private, Quite vs. Loud, Risk Adverse or Risk Acceptance; etc (the things that make up “Fun” and “Risk”), and Cost—What the client is willing to spend on the activity (optional).

These selections can be modified to best determine what it is the provider needs to understand about the client. For example the provider may be a Hardware Store or Real Estate Provider. In this case the profile would include categories for style and taste and would not need to include other categories. The provider may be a restaurant where cultural food types (French, Italian, etc) or romantic ambiance (Public vs. Private, and Loud vs. Quite) would/could be factors. These preferences would then allow the provider to better understand what it is the client actually wants and desires. Each of these categories would be ranked and assigned a numerical value that would then be stored in the temporary client database. The profile is then compared with the venue database for matching sets of interests.

Another advantage that this system allows is the derivation for a family, group or organization profile from the selection of the different individual profiles. This derivation can be done using a simple averaging technique, by hierarchical system, by a family weighing system or an organizational application using combinations of the averaging and hierarchical techniques to specific client profiles (called the OV). These techniques generate a unique profile (OV) for the client that can be compared to the Venue, Product, and Service (VPS) database.

For example, let's assume that the family is 5 individuals so the total number of the party is 5. A simple averaging technique (FIG. 1B) could be used to find out what the group wants if all members of the family are seen as having equal value as to their wants, needs and desires. If it is determined that there is a hierarchical value system for the family, as set by the client, i.e. Dad, Mom, eldest to youngest, then a hierarchical weighting system (FIG. 1C) can be used to determine the values for the family unit.

The hierarchical weighting system (see FIG. 1C) would be determined by allowing the client to determine the priority of the party members. The weight would then be the total number of the party and scale down as you go down the hierarchy. In that case the multiplier of 5 would be assigned to the priority party member (Dad); the multiplier of 4 would be assigned to the 2^{nd} highest priority member (Mom), etc. This would continue to the last party member.

The multiplier would then multiply the particular value that a client has. These values would then be added up and divided by the sum of the multipliers. If N=# of party members then the formula is divider=(N+(N−1)+(N−2)+(N−x) until N−x=0 where x is the decremented value of N. In our earlier example, the group of 5 would have a divider of 15 (5+4+3+2+1=15). The resulting values would be the group's profile. If the group were 8 then the divider would be 36 (8+7+6+5+4+3+2+1=36)

An example of this for the Travel Booking for a Father, Mother, 2 Sons and a baby girl, would be the following (using table 1):

| | | 1 | 2 | 3 | 4 | 5 |
|---|---|---|---|---|---|---|
| Category | | Dad | Mom | Son | Son | Daughter |
| Adventurous vs. Sedentary | AS | 8 | 6 | 9 | 8 | 3 |
| Age: young vs. Old | YO | 6 | 6 | 5 | 4 | 2 |
| Tactile vs. non-tactile | TN | 7 | 5 | 8 | 7 | 6 |
| Participatory vs. Observation | PO | 6 | 4 | 8 | 8 | 3 |
| Aggressive vs. Passive | AP | 6 | 3 | 6 | 4 | 2 |
| Science vs. Art | SA | 7 | 3 | 7 | 5 | 2 |
| Hazardous vs. Safety | HS | 5 | 3 | 8 | 6 | 1 |
| Scary vs. Humorous | SH | 6 | 2 | 8 | 8 | 1 |
| Adult theme vs. Family Friendly | XF | 6 | 4 | 1 | 1 | 1 |
| Risk Acceptance Vs Risk Adverse | RA | 6 | 5 | 7 | 8 | 3 |
| Cost | CO (optional) | | | | | |

Simple averages

| | | | | | | | | | | | | | | | | | | | | |
|---|---|---|---|---|---|---|---|---|---|---|---|---|---|---|---|---|---|---|---|---|
| Totals | AS | 34 | YO | 23 | TN | 33 | PO | 29 | AP | 21 | SA | 24 | HS | 23 | SH | 25 | XF | 13 | RA | 29 |
| Group average | AS | 6.8 | YO | 4.6 | TN | 6.6 | PO | 5.8 | AP | 4.2 | SA | 4.8 | HS | 4.6 | SH | 5 | XF | 2.6 | RA | 5.8 |
| Weighted Totals | AS | 110 | YO | 79 | TN | 99 | PO | 89 | AP | 70 | SA | 80 | HS | 74 | SH | 79 | XF | 52 | RA | 90 |
| Weighted Average | AS | 7.3 | YO | 5.2 | TN | 6.6 | PO | 5.9 | AP | 4.6 | SA | 5.3 | HS | 4.9 | SH | 5.2 | XF | 3.5 | RA | 6 |

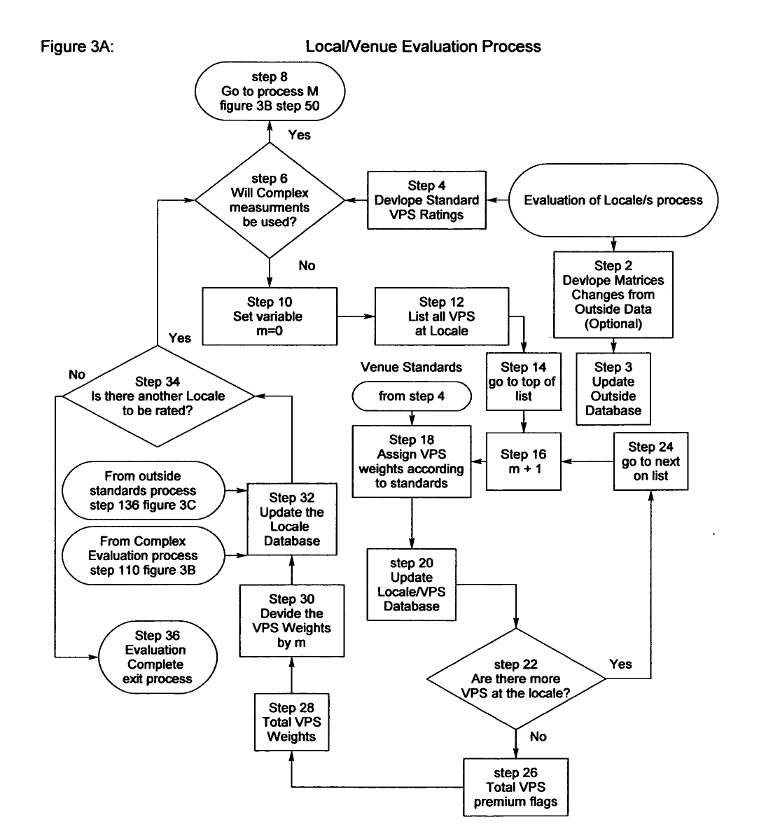

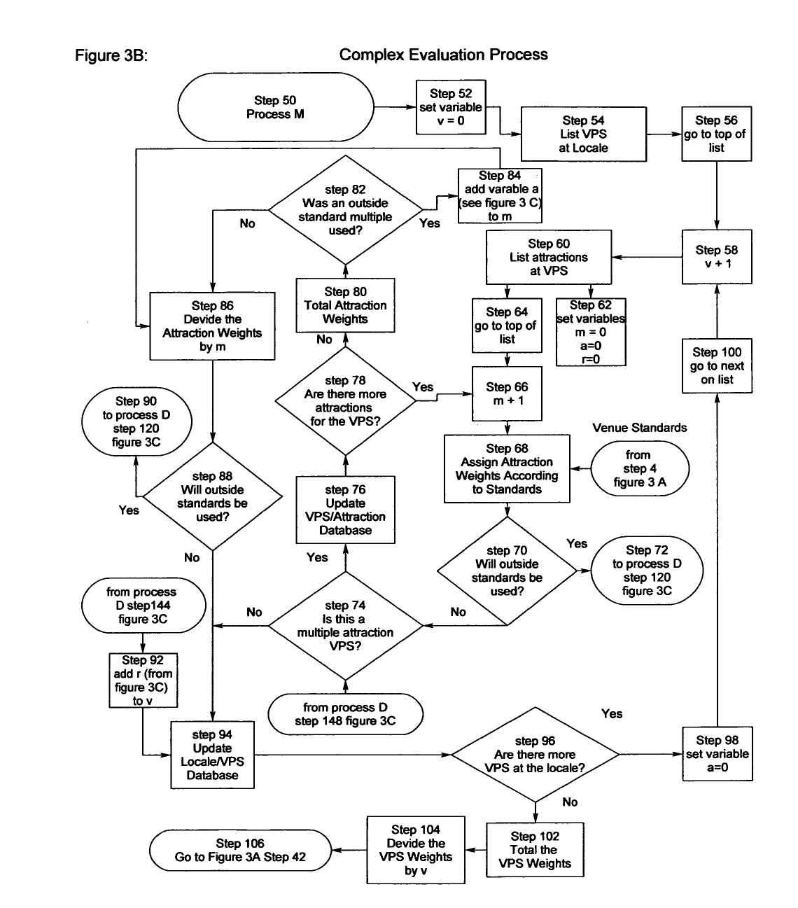

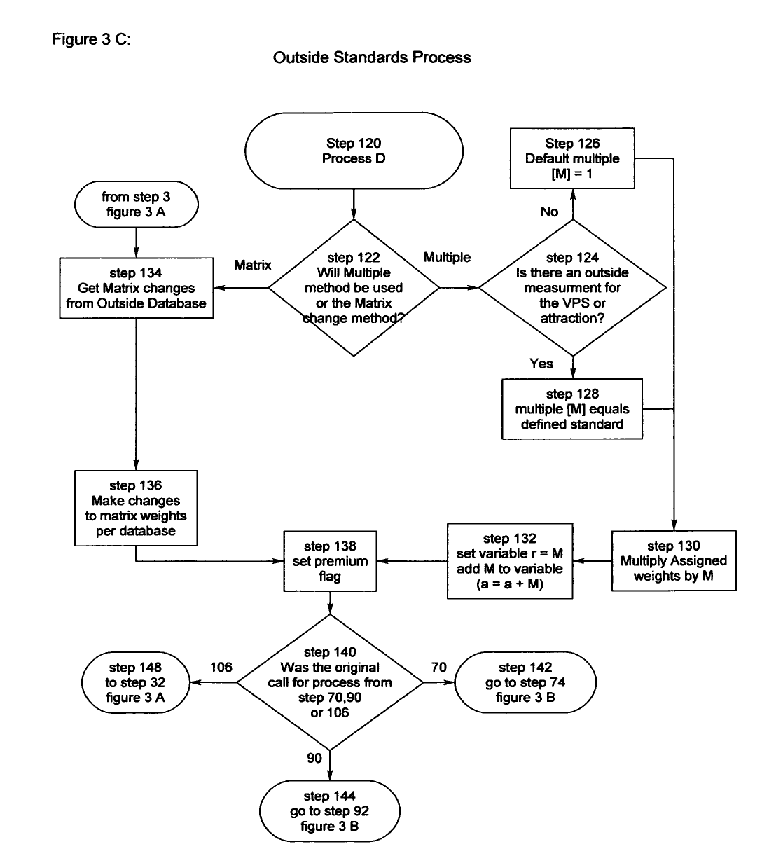

Family weighing (see FIG. 3) is more complicated. This is actually a subset of the organizational process (FIG. 1E) that is particularly useful with family settings where the parents are grouped together and seen as equals as to where and what they want to do/see/experience and separate groups for the children who can be broken down to even smaller groups as required. It requires the client to equate individuals within the grouping. The internal individuals within the groupings are averaged as they are seen as equals. The groups seen as hierarchical and are assigned appropriate weights. The totals for the separate groups are developed and they are divided according to the number of groupings there are. For example a family of 8 accesses the system. Mom and Dad are considered 1 group, oldest son and daughter are the 2^{nd} group, the next 3 kids are the 3¹¹ group and the baby is the last group (4).

| | | 1 | 2 | 3 | 4 | 5 | 6 | 7 | 8 |
|---|---|---|---|---|---|---|---|---|---|
| Category | | Dad | Mom | Son | Daughter | Daughter | Son | Son | Daughter |
| Adventurous vs. Sedentary | AS | 8 | 6 | 9 | 8 | 6 | 6 | 6 | 2 |
| Age: young vs. Old | YO | 6 | 6 | 5 | 4 | 4 | 4 | 4 | 1 |
| Tactile vs. non-tactile | TN | 7 | 5 | 8 | 7 | 5 | 5 | 5 | 5 |
| Participatory vs. Observation | PO | 6 | 4 | 8 | 8 | 5 | 7 | 7 | 2 |
| Aggressive vs. Passive | AP | 6 | 3 | 6 | 4 | 2 | 5 | 7 | 1 |
| Science vs. Art | SA | 7 | 3 | 7 | 5 | 5 | 5 | 5 | 1 |
| Hazardous vs. Safety | HS | 5 | 3 | 8 | 6 | 3 | 6 | 6 | 1 |
| Scary vs. Humorous | SH | 6 | 2 | 8 | 8 | 2 | 5 | 6 | 1 |
| Adult theme vs. | XF | 6 | 4 | 3 | 1 | 1 | 1 | 1 | 1 |
| Family Friendly | | | | | | | | | |
| Risk Acceptance vs. | RA 6 | 5 | 7 | 4 | 3 | 8 | 5 | 1 | 1 |
| Risk Avoidance | | | | | | | | | |

| Group averages | AS | YO | TN | PO | AP | SA | HS | SH | XF | RA |
|---|---|---|---|---|---|---|---|---|---|---|
| 1 | 7 | 6 | 6 | 5 | 4.5 | 5 | 4 | 4 | 5 | 5.5 |
| 2 | 8.5 | 4.5 | 7.5 | 8 | 5 | 6 | 7 | 8 | 2 | 5.5 |
| 3 | 6 | 4 | 5 | 6.3 | 4.6 | 5 | 5 | 4.3 | 1 | 5.3 |
| 4 | 3 | 2 | 6 | 3 | 2 | 2 | 1 | 1 | 1 | 1 |

Therefore AS=(7*4)+(8.5*3)+(6*2)+(3*1)=68.5 68.5/10=6.9
YO=(6*4)+(4.5*3)+(4*2)+(2*1)=47.5 47.5/14.8

etc. . . .

Weighted group totals AS 68.5 YO 47.5 TN 62.5 PO 59.6 AP 44.2 SA 50 HS 48 SH 49.6 XF 29 RA 50.1

This will be divided by 10 (4+3+2+1=10). Using this sort of system allows the user to determine the complexity of their group and the resulting group profile. This process allows the system to be flexible for the user. Determining the default method of defining grouping would be up to the provider.

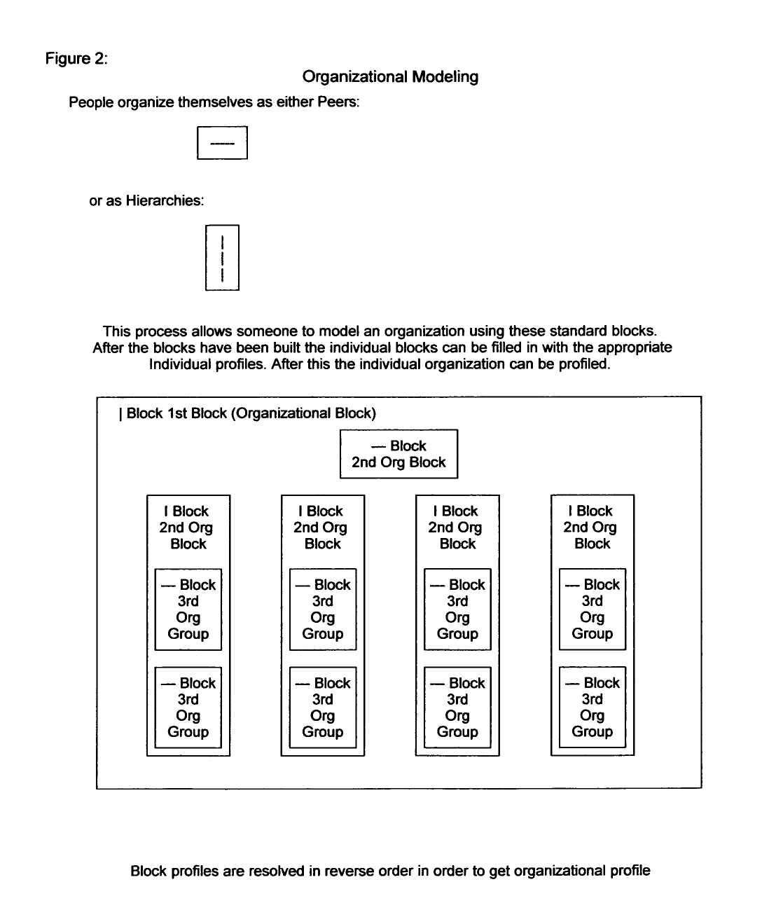

The last part of the profiling process allows for the creation of an organizational profile (FIG. 1 E). The organizational profile allows for the creation of an overall organizational management structural block (FIG. 2). This is either a Peer (averaging) or a Hierarchical block. Then smaller peer or hierarchical blocks are placed within the organizational structural block. These building blocks are generated to represent the organizational structure as it is, or if modeling, as one would like it to be. Then individual profiles are placed within the different blocks. Once that has been completed then the system goes through its processes to generate a complete organizational profile. This can be particularly useful for a company that wants to evaluate its client facing operations or how different members of an organization can work with each other to generate a more effective and efficient organization when setting up work for specific projects or contracts.

As part of the final profile part of the process the system can generate sub-groupings (FIG. 1F), or micro-groups, for groups. This would be helpful for families who want to spend quality time for specific parings of the two parents, parent and a child, or group of children. These are matched against specific venues at a locale.

As part of the profile completion process (FIG. 1H) the client's OV Profile is compared against the Product, Service, Venue (PVS) database and the best matches are offered in order for selection by the client. It is possible that during this process that the system could come across a possibility that a couple of locales or venues could end up having the same or very closely the same OV values and the system would have a problem deciding which one to offer 1^{st}. To help over come this problem we could utilize a simple Brute Force (Figure G) evaluation technique. This could be run against the entire database but it would not be as efficient as if it was run against just those locales or venues that are in conflict. The brute force system technique would more effective evaluating each attraction and venue for a specific match, or very close match (a percentage to be designated by the provider), to the designated OV profile value or the group of OV profiles (if a group). Because the nature of the Brute Force technique requires the extended use of resources it is recommended that the presentation of equal OV profiles be made in a system define manner such a alphabetically, closest 1^{st} match etc.

It should be noted that when a brute force technique is used then we run up against a problem with ages. This is because there is little difference between 34 and 36 year olds but a huge difference between 3 and 6 year olds. This means a difference of 10% will not work for age. When Brute Force is used age should be evaluated in blocks as each of these blocks have something specifically unique about their particular group. Something like the following:

0-6 months

6 months to 1 year

1-2 year

2-3 year

4-6 year

6-8 year

8-10 year

10-13 year

13-16 year

17-18 year

18-21 year

21-30 year

30-45 year

45-60 year

60-75 year

75+

There are other ways to handle groupings. One way that works well with small groups and on the internet is to allow someone to enter the names of the people in the group in a priority order. Except for the 1^{st} name each time a new name is entered the user is either prompted or asked to check a block if the new name is a peer to the person just listed earlier. This sets up a priority of groups and peers. If a peer prompt is not affirmed, or the peer check box not checked, then a new group is established and a new set of peers can be created. (See FIG. 1I)

Another way of handling this is to just allow the user to enter the names and the priority at the same time or to allow them to set the priority after they have entered the names. With this idea it would be possible to treat the groups that have the same priority as peers, the priority levels could also be broken down into sub-groupings by using alphanumerics as well. Using the alphanumeric system also allows a command line creation of a larger organizational group instead of a web based block form, but the logic may be more difficult to understand by a user. (FIG. 1I can still be used in this situation but you would begin at step 320.)

Using the ticking booking system as an example the client has selected the local and then they are offered a chance to select sub-groupings. A sub-grouping a normally a coupling of a primary group member (Mom or Dad) with a secondary group member (a child). These sub-groupings would then be compared against the PVS database for specific venues that would best match the sub-groupings and these would also be offered to the client. Compare how families normally operate on vacation. It is common for a family to break up temporally, Mom may take a son(s) or daughter(s) as well as Dad and that couples/groups will go off to do something together. It is also common that the parents will focus on what it is that the child (member of the secondary group) wants to do. Therefore the sub-grouping process allows for the setting of weights for the members of the sub-groups. After the matches with the venues are made the client is sent to other parts of the provider's web site to make the necessary arrangements for going to these locales, getting tickets for specific venues, or start to make the necessary plans to go to the destination of their choice.

This next part of the process is what allows you to rate “Fun or Risk and other, previously non-quantifiable human values.” We apply an observable profile from a set of standards, which are similar to the personality profiles requested of our clients, to an object, service or venue. From this set of standards a PVS database is developed and you can derive what is meaningful and of value to the individual or the group when the personality profile is compared to the PVS database. Thus you can derive goods, products, services and venues that the client would identify with.

The second database is owned by the vendors or providers. There are at least 3 ways to accomplish products, services, and venue/vendor grading. A simple system is where an internal standard is used to grade a venue, product or service in relation to the personality traits being sought from the client. This means that all products, services or venues of the same type have the same values. A complex system is where a venue/product or service is the sum of its internal component constituents. The third system allows for modification of the standards according to a provider recognized outside grading system. An example of this would be an inclusion to the standards a variable that references an International comparison of Roller Coasters. Amusement parks with Roller Coasters that have a high rating should have a different OV value of an amusement park without a highly rated Roller Coaster or Coasters. Even the amusement parks themselves have external ratings that can be included. Using any of these systems will require that a standard must be kept to in order to make sure that these venue ratings were stable. The same could be said of 4 and 5 star restaurants or resorts. This allows for the addition of “value added” to a product, service or a venue so long as that “added value” is from a recognized, objective outside source from that which is being graded. This helps separate advertisement claims from reality.

Using the standards developed by the manufacture or provider, you can rate the type of “Fun or Risk”. One can rate how good the “Fun or Risk” is by looking at the participation rates but that can be affected by the size of the local population at the venue so small venues can be adversely affected by using this as a standard. By using a set of developed standards for a common set of products, services or venues we can avoid this trap and using participation rates is really not required for a simple system (see FIG. 3A). What is required for the system is recognition of the types of products, services or venues and the type of “Fun or Risk” offered. Therefore a simple standard per product, venue or service is required and assigned per venue or service at the locale or service.

Simple Locale or Service Rating System
1) Decide on a specific standard for each type of product, service or venue that should be encountered.
2) Choose a specific locale, global set of products, or services that you want to rate.
3) Determine all the products, services or venues available within the global selection set.
4) Rate the venues or services according to the standard already developed.
5) Total and place in the database the specific ratings.
6) These are now the locale, product or service profile that can be used to compare against the client's profile.

### Example:

Attractions and venues would need to be evaluated according the following criteria to determine how much “Fun” it may have (Note: this list is not to be considered to be complete, this is to be used as an example only):

| | |
|---|---|
| Adventurous vs. Sedentary | AS |
| Age: young vs. Old | YO |
| Tactile vs. non-tactile | TN |
| Participatory vs. Observation | PO |
| Aggressive vs. Passive | AP |
| Science vs. Art | SA |
| Hazardous vs. Safety | HS |
| Scary vs. Humorous | SH |
| Adult theme vs. Family Friendly | XF |
| Risk Adverse vs. Risk Acceptance | RA |
| Daily vs. Annual | DA (optional multiplier or seasonal |
| | addition/subtraction) |
| Cost | CO (Optional) |
| (See Table 1) | |

An example of how a locale or community can be rated can be seen in Table 2. With a simple averaging system the OV can be determined. For our example Locale (from Table 2) we get the following Average OV matrix value:

Locale Profile average AS 6.4 YO 4.8 TN 5.7 PO 7.4 AP 5.3 SA 4.6 HS 5.0 SH 5.4 XF 3.7 RA 2.9

### Complex System

Of the Towns venues, the Amusement park can be broken down further. There are multiple components, or venues, within the amusement park (see FIG. 3B). Therefore the different components of the amusement park can be evaluated and a composite OV matrix can be determined. So the following would be true for these venues, (Note: in Beta testing it was determined that keeping the values of fast food and family restaurants can dilute the results. It is recommended that these be left out of the equation else almost all locations end up reflecting the total number of fast-food/family restaurants in the location):

Amusement Parks

| | | | | | | | | | | | | | | | | | | | | | | | |
|---|---|---|---|---|---|---|---|---|---|---|---|---|---|---|---|---|---|---|---|---|---|---|---|
| 1 | Water | AS | 9 | YO | 8 | TN | 8 | PO | 9 | AP | 8 | SA | 5 | HS | 7 | SH | 7 | XF | 6 | RA | 6 | DA | 1.0 |

Water Park:

| | | | | | | | | | | | | | | | | | | | | | | | |
|---|---|---|---|---|---|---|---|---|---|---|---|---|---|---|---|---|---|---|---|---|---|---|---|
| 5 | Water | AS | 9 | YO | 8 | TN | 8 | PO | 9 | AP | 8 | SA | 5 | HS | 7 | SH | 7 | XF | 6 | RA | 7 | DA | 1.0 |
| | Slides | | | | | | | | | | | | | | | | | | | | | | |
| 1 | Wave | AS | 6 | YO | 5 | TN | 8 | PO | 8 | AP | 5 | SA | 4 | HS | 5 | SH | 5 | XF | 6 | RA | 5 | DA | 1.0 |
| | Pool | | | | | | | | | | | | | | | | | | | | | | |
| 1 | Lazy | AS | 3 | YO | 6 | TN | 8 | PO | 8 | AP | 3 | SA | 3 | HS | 2 | SH | 2 | XF | 6 | RA | 2 | DA | 1.0 |
| | River | | | | | | | | | | | | | | | | | | | | | | |
| 1 | 4 Star | AS | 5 | YO | 5 | TN | 8 | PO | 7 | AP | 2 | SA | 6 | HS | 8 | SH | 5 | XF | 7 | RA | 2 | DA | 1.0 |
| | Res- | | | | | | | | | | | | | | | | | | | | | | |
| | taurant | | | | | | | | | | | | | | | | | | | | | | |

| | | | | | | | | | | | | | | | | | | | | | | |
|---|---|---|---|---|---|---|---|---|---|---|---|---|---|---|---|---|---|---|---|---|---|---|
| Combined | AS | 59 | YO | 56 | TN | 64 | PO | 66 | AP | 42 | SA | 38 | HS | 50 | SH | 47 | XF | 49 | RA | 44 | DA | 10.0 |
| totals | | | | | | | | | | | | | | | | | | | | | | |
| Combined | AS | 7.4 | YO | 7.0 | TN | 8.0 | PO | 8.5 | AP | 5.3 | SA | 4.8 | HS | 6.3 | SH | 5.9 | XF | 6.1 | RA | 5.5 | | |
| Average | | | | | | | | | | | | | | | | | | | | | | |

Replacing the new values for the amusement park would yield the following OV for the locale:

Totals AS 388.4 YO 294 TN 346 PO 452.5 AP 323.3 SA 283.8 HS 306.3 SH 325.9 XF 226.1 RA 174.5

Total venues 61

Complex Local Profile AS 6.4 YO 4.8 TN 5.7 PO 7.4 AP 5.3 SA 4.7 HS 5.0 SH 5.4 XF 3.7 RA 2.9

### Modified Complex Locale Rating System

Outside of just assigning a group of venues as specific set of standards, a particular type of venue could be assigned a standard set with a variable allowance (see FIG. 3C) if there is a set of common standards that have already been accepted (i.e. Roller Coasters, Restaurant ratings, etc.). Then each individual business within the venue could be rated separately, instead of collectively. The result would be combined just as it was done in the Complex Locale Rating System. The variable would be judged by using an outside set of standards. An example of this would be the International Rollercoaster rating system, the hoteliers rating system, independent restaurant rating systems. These variables would then be applied to the standard.

Using this type of standard system the providers can become as detailed as they want. For example, the travel system can go from rating a locale from just the type of venue with common standards, to rating the venue itself incorporating all its various components, to including an accepted, outside standard measure or a combination of these.

There are 4 ways to incorporate outside standards:
1) Use a multiple
2) Allow for increases/decreases for separate matrices
3) Attach a flag to the attraction that lets the system know that this is a premium/top attraction
4) A combination of the previous 3.

Advantages/disadvantages of these 3 methods are:
1) The advantage to using the multiple is that it has a better chance of affecting the venue's overall metric. The disadvantage is that the multiple can also change the metric in such a way as to make the attraction's profile not reflect a more realistic representation of the venue itself.
2) Changing specific matrices within the attraction metric may better represent the attraction but may not affect the venue's profile greatly.
3) If we add a specific flag noting that the attraction is seen as being noted as being special can allow the venue to be highlighted to the user during the user profile, venue matching phase but will not affect the venue's profile at all.
4) Combining adding a flag and changing specific matrix for the attraction would be the best way to handle this as it allows for the change in the matrix that better reflects the value of the venue and flags the attraction, venue, or locale for specific notice of the client later on as something special.

A demonstration of this would be a 4 star restaurant with a common standard of:

AS 5 YO 5 TN 8 PO 7 AP 2 SA 6 HS 8 SH 5 XF 7 RA 2 DA 1.0

with a variable of plus or minus 2 per standard because of the inclusion of an acceptable outside standard. For this demonstration we will assume several of the restaurants at the site have an international rating and a top Chef. There can now be an argument to increase the rating of the 4 Star restaurants to:

AS 7 YO 7 TN 8 PO 8 AP 4 SA 4 HS 8 SH 5 XF 7 RA 2 DA 1.0. and setting a premium flag for the restaurant. This would be entered into the system and incorporated into the overall rating of the locale.

Using the previous example (see Table 2, page 33) suppose that the small community decided to use the process and decided to focus on tourism, to accomplish this goal they were able to work with local businessmen and brought in top chefs for their restaurants and now these restaurants were ranked nationally; they decided to promote the cultural aspect of their local carnival/fair and were now recognized in the nation as being a great place to go to; and the town was lucky enough to be located next to one of the nations best national Parks/Forests.

Dining

| | | | | | | | | | | | | | | | | | | | | | | | |
|---|---|---|---|---|---|---|---|---|---|---|---|---|---|---|---|---|---|---|---|---|---|---|---|
| 1 | 5 Star | AS | 2 | YO | 6 | TN | 9 | PO | 8 | AP | 2 | SA | 7 | HS | 8 | SH | 5 | XF | 8 | RA | 2 | DA | 1.0 |
| 3 | 4 Star | AS | 5 | YO | 5 | TN | 8 | PO | 7 | AP | 2 | SA | 6 | HS | 8 | SH | 5 | XF | 7 | RA | 2 | DA | 1.0 |

Is now changed to
Dining

| | | | | | | | | | | | | | | | | | | | | | | | |
|---|---|---|---|---|---|---|---|---|---|---|---|---|---|---|---|---|---|---|---|---|---|---|---|
| 1 | 5 Star | AS | 4 | YO | 7 | TN | 9 | PO | 8 | AP | 4 | SA | 9 | HS | 8 | SH | 5 | XF | 8 | RA | 2 | DA | 1.0 |
| 3 | 4 Star | AS | 7 | YO | 6 | TN | 8 | PO | 7 | AP | 4 | SA | 7 | HS | 8 | SH | 5 | XF | 7 | RA | 2 | DA | 1.0 |

Amusement Parks

| | | | | | | | | | | | | | | | | | | | | | | | |
|---|---|---|---|---|---|---|---|---|---|---|---|---|---|---|---|---|---|---|---|---|---|---|---|
| 1 | Carnivals | AS | 6 | YO | 5 | TN | 7 | PO | 7 | AP | 7 | SA | 5 | HS | 6 | SH | 6 | XF | 2 | RA | 5 | DA | .1 |

Is now changed to

| | | | | | | | | | | | | | | | | | | | | | | | |
|---|---|---|---|---|---|---|---|---|---|---|---|---|---|---|---|---|---|---|---|---|---|---|---|
| 1 | Carnivals | AS | 8 | YO | 5 | TN | 8 | PO | 8 | AP | 7 | SA | 7 | HS | 4 | SH | 5 | XF | 2 | RA | 5 | DA | .1 |

Parks

| | | | | | | | | | | | | | | | | | | | | | | | |
|---|---|---|---|---|---|---|---|---|---|---|---|---|---|---|---|---|---|---|---|---|---|---|---|
| 1 | Federal | AS | 6 | YO | 5 | TN | 6 | PO | 7 | AP | 5 | SA | 6 | HS | 6 | SH | 5 | XF | 6 | RA | 4 | DA | 1.0 |
| 1 | State | AS | 6 | YO | 5 | TN | 6 | PO | 7 | AP | 5 | SA | 6 | HS | 6 | SH | 5 | XF | 6 | RA | 4 | DA | 1.0 |
| 3 | Local | AS | 6 | YO | 5 | TN | 6 | PO | 7 | AP | 5 | SA | 6 | HS | 6 | SH | 5 | XF | 6 | RA | 3 | DA | 1.0 |
| 1 | Lake | AS | 6 | YO | 4 | TN | 7 | PO | 8 | AP | 6 | SA | 5 | HS | 6 | SH | 5 | XF | 7 | RA | 4 | DA | 1.0 |
| 3 | Trails | AS | 8 | YO | 4 | TN | 7 | PO | 9 | AP | 6 | SA | 5 | HS | 6 | SH | 5 | XF | 5 | RA | 3 | DA | 1.0 |

Is now changed to

| | | | | | | | | | | | | | | | | | | | | | | | |
|---|---|---|---|---|---|---|---|---|---|---|---|---|---|---|---|---|---|---|---|---|---|---|---|
| 1 | Federal | AS | 7 | YO | 5 | TN | 6 | PO | 8 | AP | 6 | SA | 4 | HS | 4 | SH | 5 | XF | 4 | RA | 4 | DA | 1.0 |
| 1 | State | AS | 6 | YO | 5 | TN | 6 | PO | 7 | AP | 5 | SA | 6 | HS | 6 | SH | 5 | XF | 6 | RA | 4 | DA | 1.0 |
| 3 | Local | AS | 6 | YO | 5 | TN | 6 | PO | 7 | AP | 5 | SA | 6 | HS | 6 | SH | 5 | XF | 6 | RA | 3 | DA | 1.0 |
| 1 | Lake | AS | 6 | YO | 4 | TN | 7 | PO | 8 | AP | 6 | SA | 5 | HS | 6 | SH | 5 | XF | 7 | RA | 4 | DA | 1.0 |
| 1 | Trails | AS | 6 | YO | 5 | TN | 7 | PO | 9 | AP | 5 | SA | 5 | HS | 5 | SH | 5 | XF | 5 | RA | 2 | DA | 1.0 |
| 2 | Trails | AS | 8 | YO | 4 | TN | 7 | PO | 9 | AP | 6 | SA | 5 | HS | 6 | SH | 5 | XF | 5 | RA | 3 | DA | 1.0 |

This changes the totals for the locale to:

Totals AS 397.4 YO 299 TN 347 PO 462.5 AP 331.3 SA 288.8 HS 300.3 SH 324.9 XF 224.1 RA 173.5

Total venues 61

Modified Complex Local Profile AS 6.5 YO 4.9 TN 5.7 PO 7.6 AP 5.4 SA 4.7 HS 4.9 SH 5.3 XF 3.7 RA 2.8

A comparison of the 3 yields:

Average Local Profile AS 6.4 YO 4.8 TN 5.7 PO 7.4 AP 5.3 SA 4.6 HS 5.0 SH 5.4 XF 3.7 RA 2.9

Complex Local Profile AS 6.4 YO 4.8 TN 5.7 PO 7.4 AP 5.3 SA 4.7 HS 5.0 SH 5.4 XF 3.7 RA 2.9

Modified Complex Local Profile AS 6.5 YO 4.9 TN 5.7 PO 7.6 AP 5.4 SA 4.7 HS 4.9 SH 5.3 XF 3.7 RA 2.8

Once the system has been driven down into a very detailed level then other things can now start to happen. Once a very fine point of detail the level has been reached, then amusement park planners can now start to design their parks with specific demographics in mind. They will start combining the specific rides, restaurants and other amusements to reach a specific OV profile. This same sort of detail will also allow city planners to allocate space in the community to different venues so as to give the city a specific OV profile.

Once a certain point of detail has been reached, then the consumer can also drill down into the local level as well. The clients can then look at the community and see what venue specifically meets his/her/or the groups profile the best. A matching profile has the best chance of being a venue that the client will enjoy. Then the client has the best chance to arrange his/her/or the group's time to be the most effective use of their limited time budget. Now the consumer can start to identify specific itineraries for their family, or even break up the family unit during different parts of the plan so that Mom and the kids, dad and the kids, or just the kids have a specific plan of action for a specific day.

Automated Real Estate services were mentioned in the abstract. Currently, Real Estate tools assist the agent in identifying the basics of what the client wants. The tools focus on the basic physical aspects of the client's desired home such as distance from work, single or multiple story, etc. . . . These tools are not able to focus on other qualities such as how a neighborhood might fit into the client's family's personality or dynamic. A good agent will be able to know these things about the neighborhood and be able to enter these dynamics into the system. Matching the Client's OV to a specific neighborhood or neighborhoods would allow the agent to focus the client there; this would be particularly helpful if the agent has not gone through that particular neighborhood. It would also allow a client to utilize remote Real Estate software from home much more effectively. This would be particularly true for those clients who are going to be relocated from one city to another. It could be envisioned that utilizing this sort of software along with another tool web tool that allows you to view street locations from a web map (i.e. Google's Street view tool) a consumer could then actually buy the home before they ever get to the new location. This will speed up the process for the Real Estate agencies and get a match between home buyer and home seller sooner. Allowing a better level of client interface with the automated tool at the beginning of the Real Estate search will speed up everything and it is the rate of house purchases that quickens the local economy.

Using the process as a tool to monitor brokers has been discussed. A client's profile can be matched against what products that they currently have and what is going to be offered. If a manager sees that one of his/her staff is going to offer, or has offered, a product that would be detrimental to the client's goals/desires. The system would be able to flag that transaction for management review. As most mangers have not had a chance to meet with the client, this tool would give them a chance to understand what a client's real goal is and prevent losses to a client, and the resulting law suites that follow. This will assist the Brokerage Firm in determining when a broker gets more involved with making a profit for themselves as opposed to making a profit for their client.

Products and services have been discussed. A company can start to look at their suite of products and services utilizing the process that this patent has expanded upon and then decide what type of individual would be best at utilizing their product or service. A set of standards can then be attached to each product. The company's clients can then be shown those products and services that this process shows that they most identify with first. Thus the client has a better chance of seeing a need for the product or service, thus providing the incentive to make a purchase. This would be of particular interest in identifying gifts to other individuals.

By means of this invention the various web applications can now become proactive with their clients in a way that was not available to them earlier. If the provider can become proactive with their clients then the provider has a better chance of being able to service the client in a way that the client will enjoy and the client will come back at a later date for repeat business. By incorporating the personality profile into the business plan instead of just the client's buying patterns the company can now tie into the client's desires as well as the client's needs and wants. The client can now expect to be offered options that they had not thought of before. Once communities reach this sort of detailed profile, the community planners can start to offer their community services to their own people in a way that their community wants. The community can start to plan for people wants and desires and not just for their current needs. Communities that focus on tourism can decide that a particular venue may not provide the proper sort of profile that they want and could encourage business to develop the venue that they do want. Communities that want to focus on specific businesses can use this process to make the necessary changes to their structure to make their communities more desirable. This invention is an advantage to business, clients and to communities.

### Step-by-Step Process Description

There are 2 Main processes. The first is for developing the user/group profile process the second is for developing the service/product/venue process.

### User/Group Profile Process

FIG. 1A Step 2—User access the system via World Wide Web—Step 4—User is asked to generate a user profile—Step 6 the user profile is stored in the temporary user database (it is normally counter productive to permanently store the user profiles)—Step 8—User is asked if they are profiling an individual (go to step 14) or a family/group (go to step 10)—step 10—the user is asked if more profiles are needed for the family/group, if more profiles are needed go to step 4 if not proceed to—step 12—User defines what sort of group/family that they have, the user has 4 choices, (1) simple averaging for the situation where all members of the group/family are seen as equals, go to step 30 Process A; (2) Hierarchy weighted where a group/family is prioritized highest to lowest. The higher the priority, the greater weight that profile has in determining the group profile, go to step 60 process B; (3) Family system, this a complex weight system, this allows a user to form groups that can have multiple individuals within them, the groups themselves are prioritized go to step 90 Process C; (4) Organizational Weighting system. This has been developed for the use of complex organizations that integrate the previous forms of organization within 1 overall structure. This allows the user to set up organizational blocks within organizational blocks and allows the system to relate the organizational blocks themselves as if they were individual profiles go to step 140—step 14—Provide the user with the profile result, this allows the user to see what the results were for the grouping processes (steps 38, 84, 130 and 176) and as a way for the user to verify the profile that they provided earlier if they are single—step 16—Does the profile match what the client was expecting? If no go back to start, step 2; if yes go to step 18—go to step 270 the User Profile Completion Process

FIG. 1B Step 30 Process A used when the group are peers—Step 32—Profiles are averaged together—step 34—the result of the averaging in step 32 is the profile composite—step 36—is the resulting profile for a peer group go to step 38, family profile go to step 40 or part of an Organizational profile go to step 42—step 38—provide results to user process (FIG. 1A step 14)—step 40—provide results to the family weighting process (FIG. 1D step 106)—step 42—provide the results to the Organizational process (FIG. 1E step 158)

FIG. 1C step 60—This is the Hierarchy weighting process that is used when the group members are to be considered to have a hierarchy and that their profiles should reflect the hierarchy. This process can be used for a simple group or as part of a larger complex organizational process—step 62—total the number of user profiles in the group. Assign this number to the variable u and to constant N—step 64—User decides the user profile priority, or hierarchy. The 1^{st} person of the list has the highest priority and is designated the Priority user—step 66—Does the priority user have an assigned weight of 1? if not proceed to step 68, if the priority user has an assigned weight of 1 go to step 74—step 68—Assign priority user the assigned weight of u—step 70—decrement variable u by 1—step 72—go to the next name on the list, that person is designated the priority user, if there are no more names on the list that last person stays as the priority user, go to step 66—step 74—Multiply the user profiles by the assigned weight—step 76—add all profiles—step 78—Divide the user profiles by the formula: N+(N−1)+(N−2)+ . . . +1—step 80—the result of this number is called the composite profile—step 82—Is this a user/group profile go to step 84, or an organizational profile go to step 86—step 84—provide results to user process (FIG. 1A step 14)—step 86 provide results to Operational group (FIG. 1E step 158)

FIG. 1D step 90—The family grouping system is a complex system that allows one to organize a hierarchy of groups. These groups can be made up of 1 or more individuals. The individuals within the groups are seen as peers. This sort of arrangement is very effective with family groups where it is often seen that Mom and Dad are the priority group and there can be multiple secondary groupings made up of the younger children in the family. This can also be used for small organizations, or groups within a larger organization—step 92—User specifies how many groups there will be—step 94—Assign the total number of groups to variable g and to constant M—step 96—user places the individuals in each group from the profiles that the user has already created from steps 4 thru 10—step 98—User decides the group priority, or hierarchy and lists them—step 100—Do all of the groups in the group list have a composite weight? If yes go to step 114, if no go to step 102—step 102—go to the top of the group list—step 104—Is there more than profile in the group? If yes go to step 106, if no go to step 108—step 106—pass all profiles in the group to process A, FIG. 1B step 30—step 108—this is the composite profile, data from process A step 40 can be inputted as the composite profile if there was more than 1 member from that group—step 110—is this the last group in the list? If yes go to step 114, if no go to step 112—step 112—go to the next group in the group list, go to step 104—step 114—Go to the top of the group list, the 1^{st} group is designated the priority group—step 116—Does the priority group have an assigned weight? If yes go to step 122, if no go to step 118—step 118—Assign the priority group the assigned weight of g—step 119—decrement g by 1—step 120—step down the group list, this next group now becomes the priority group, if the group is the last on the list it will remain the priority group, go to step 116—step 122—Multiply the profiles by the assigned group weight—step 124—add all the profiles—step 126—Divide the user profiles using the formula M+(M−1)+(M−2)+ . . . +1—step 128 the result is the final composite profile for the family—step 130—provide the final composite profile to the user process (FIG. 1A step 14)

FIG. 1E step 140—Organizational process, this is used for larger organizations or for internal parts of larger organizations—step 142—User choose a Hierarchy or a Peer building block for the organizations overall management structure, this is the organizational block—step 144—User then populates the Management block with Hierarchy and Peer building blocks to reflect the actual organizations structure—step 146—the system generates an initial diagram/list of upper level blocks for the user to review—step 148—User makes changes, if required, to the diagram/list—step 150—User populates all the building blocks with the user profiles that were generated in steps 4 thru 10—step 152—System examines the first block on the list—step 154—Check to see if there is a building block without a composite profile within the current building block, if yes go to step 156, if no go to step 158—step 156—go to the unresolved block, proceed to step 154, this is a looping process because you can have multiple blocks within blocks when organizations are built. While an organizations goal may to flatten out its structure as much as possible, due to budget, legal, or other restrictions that may not be possible. The purpose of this loop is to get to the bottom most block without a composite profile—step 158—examine block profile, accept data from process A (peer step 42) and process B (Hierarchy process step 86)—step 160—Does the profile represent the organizational block? If yes go to step 172, if no go to step 162—step 162—has the block profile been resolved? If yes go to step 164, if no go to step 166—step 164—go up 1 level on the block list, go to step 154—step 166—is this a Peer or Hierarchy group? If Peer go to step 168, if Hierarchy go to step 170—step 168—provide profiles to process A step 30—step 170—provide profiles to process B step 60—step 172—Has the Organizational Profile been resolved? If yes go to step 176, if no go to step 174—step 174—go to next group on the group list, go to step 154—step 176—provide the composite profile to the user process FIG. 1A step 14

FIG. 1F step 180—Sub-grouping process, this process was developed when we recognized that most families try to set up some sort of quality time with different members of the family separate from the larger family group. Normally this is 1-on-1 time between the mother-child and father-child. This can also be used for small organization teams as well. Most often this is seen with management team retreats—Step 182—User is asked to identify the primary users Mom & Dad, Sr. Management, etc. the total number of primary users is stored as a constant [P] to be used later on—step 184—User is asked to identify the secondary users (kids), lower management level members, the total number of secondary users is stored as a constant [S] to be used later—step 186—the individual user profiles that were generated earlier in steps 4 thru 10 are pulled out of the temporary database for use—step 188—User decides if they want the system to use default weights (X=1, p=X, s=2X) go to step 190 or does the user want to define the weights themselves go to step 192—step 190—system needs an input from the user as to how large the sub-groups will be, this number is stored as constant N—step 192—user designates the weights for Primary and secondary group X, p and s—step 194—Will the system or the user generate the sub-groupings, if system go to step 196, if user go to step 200—step 196—system generates multiple sub-groupings consisting of 1 Primary group member and (N−1) members of the secondary group, NOTE: A limit to the size of the maximum group should be considered as the processing of innumerable sub-groups can put a major drain on the system and could become a point for a DoS attack—step 198—Have all combinations for Primary and Secondary users been made? If yes go to step 204, if no go back to step 196—step 200—User identifies and selects the sub-groups, the size of the subgroup is totaled and stored as constant R1, R2 . . . —step 202—is another sub-group needed, if yes go to step 200, if no go to step 204—system generates the sub-group of all the Primaries, Mom and Dad need alone time as well—step 206—system assigns weights s and p depending if the profile was a primary or a secondary profile—step 208—System multiplies all profiles by their designated assigned weight—step 210—Primary and Secondary profiles are added together within the sub-group—step 212—Combined sub-group profile is divided by the formula (p+s1+s2+ . . . +sx)—step 214—Separate sub-group profiles are compared against the venues at the Locale selected—step 216—provide results to User Profile Completion Process FIG. 1H step 288

FIG. 1G step 220—Brute Force process—step 222—Get user profiles from the temporary user database—concurrently do steps 224 and 230—step 224—List all user profiles gathered—step 226—start at the top of the Profile list go to step 240—step 230—list all locales or venues that are in conflict (provider may wish to place a limit on this, like top ten)—step 232—go to the top of the list—List all attractions or venues to be evaluated—step 236—total all premium flags—step 240—Compare profile with the OV value—step 242—does the profile and the attraction match? If yes go to step 243, if no go to step 244—step 243—begin, or add to, a temporary attraction list—step 244—does another profile need to be evaluated? Yes go to step 246, no go to step 248—step 246—go to the next profile on the user profile list and go to step 240—step 248—does another attraction need to be evaluated? yes go to step 250, no go to step 252—step 250—go to the next attraction on the attraction list and go to steps 226 and 234 concurrently—step 252—does another locale or venue need to be evaluated? yes go to step 254, no go to step 258—step 254—go to the next locale or venue to be evaluated—step 256—go to step 234—step 258—from the temporary attraction list generate a list with the most matches or close matches associated with the locales or venues—step 260—go to user completion process FIG. 1H step 282

FIG. 1H step 270—User completion process—step 272—this step is where the user/group profile is joined/compared to the Locale Database—step 274—are there multiple profiles/OV matches or are close matches? Yes go to step 276, no go to step 282—step 276—Will the Brute Force Method be used or will the defined delivery method be used? If Brute Force go to step 278, if Defined Method go to step 280—step 278—go to the brute force process FIG. 1G step 220—step 280—Order selections using the system defined method (alphabetically, 1^{st} matrix match, etc.)—step 282—Provide users with Locale selections—step 284—User selects destination locale—step 286—Were sub-groupings requested? If yes go to FIG. 1F step 180, if no go to step 288—step 288—Provide user with venue selections that best match the client profile—step 290—ask the user if they want venue tickets, either answer takes the user out of the profile process and brings them to the client tools page.

FIG. 1I Web Based Grouping Process—This process was developed as a way for a simplified, alternate, method for handing groupings of small family groups. Step 302—start of the Web Based Grouping Process—step 304—is this the 1^{st} name in the list? If yes go to step 306, if no go to step 310—step 306—Set the x=1—step 308—set profile priority to x—step 310—Is the Peering box checked? If yes go to step 312, if no go to step 314—step 312—set profile priority to x, go to step 318—step 314—increment x by 1—step 316—set profile priority to x—step 318—Is there another name? If yes go to step 304, if no go to step 320—step 320—Set constant M=x, set variable m=x—step 322—set x=1—step 324—Average all profiles with priority of x—step 326—Multiply Average profile by m—step 328—decrement m by 1—step 330—Does x=M? If yes go to step 334, if no go to step 332—step 332—increment x by 1 go to step 324—step 334—add the profiles 1 thru M—Divide the combined profiles using the formula M+(M−1)+(M−2)+ . . . +1—step 338—Provide the result to the User Completion Process step 270

### Locale/Venue/Product/Service Evaluation Process

FIG. 3A This is the process used to evaluate a venue, service or product—step 2—Develop matrices changes and/or multiples from the outside data (use of outside data is optional)—step 3—update outside database—step 4—Client develops internal standards for venue, product or service (VPS)—step 6—Will complex measurements be used? Yes to step 8, no go to step 10—step 8—go to process M FIG. 3B step 50—step 10—set variable m=0—step 12—List all venues at Locale—step 14—go to top of list—step 16—Increment m by 1—step 18—Assign weights to VPS according to standards—step 20 update Locale/VPS database—step 22—Are there more VPS at the locale? Yes go to step 24, no go to step 26—step 24—go to next VPS on list—step 26—total VPS premium flags—step 28—total VPS weights—step 30—divide the results from step 28 by m—step 32—update the Locale/VPS database—step 34—Is there another Locale/VPS to be rated? Yes go to step 6, no go to step 36—step 36—Evaluation complete exit process

FIG. 3B Process M step 50—This is the complex evaluation process. Using this process allows a VPS to be broken down into constituent parts and allows for the introduction of outside measures—step 52—Set variable v=0—step 54—List all VPS at the Locale—step 56—go to top of list—step 58—increment v by 1—step 60—List attractions at the VPS —step 62—set variables a, m and r to zero (0)—step 64—go to the top of the list—step 66—increment m by 1—step 68—Assign attraction weights according to standards—step 70—will outside standards be used? Yes go to step 72, no go to step 74—step 72—go to process D step 120—FIG. 3C—step 74—is this a multiple attraction venue, if yes go to step 76, if no go to step 88—step 76—update VPS/attraction database—step 78—are there more attractions for the VPS to be evaluated?, if yes go to step 66, if no go to step 80—step 80—Total attraction weights—step 82—was an outside standard multiple used? Yes go to step 84, no go to step 86—step 84—add variable (a from process D) to m—step 86—divide the results by m—step 88—will outside standards be used on to evaluate the venue? Yes go to step 90, no go to step 92—step 90—go to process D, step 120—FIG. 3C—step 92—update the Locale/VPS database—step 96—Are there more VPS? If yes go to step 98, if no go to step 102—step 98—set variable a=0—step 100—go to next VPS on list, go to step 58—step 102—total VPS weights—step 104—divide the venue weights by v—step 106—Will outside standards be used to evaluate the Locale? It yes go to step 108, if no go to step 110—step 108—go to process D step 140—FIG. 3C—step 110—go to step 32—FIG. 3A.

FIG. 3C Process D. step 120, This is the outside measurements process. We can handle 2 types of outside measurements processes with this. Either a multiple can be assigned to multiply against the weights of the VPS matrix, or the VPS matrix values can be changed—step 122—will the multiple method or the matrix substitution method be used? If multiple go to step 124, if matrix go to step 134—step 124—Is there a recognized outside standard for the VPS or attraction? Yes go to step 128, no go to step 126—step 126—default multiple M is set to 1—step 128—set M per defined standards—step 130—multiply the assigned weights by M—step 132—add M to variable (a=a+M), set variable r to M (r=M)—step 134—get matrix changes from the outside database from step 3 FIG. 3A—step 136—make changes to matrix weights per database—step 138—set premium flag for the Attraction, Venue or Locale—step 140—was the original process call from step 70, 90 or 106? If 70 go to step 142, if 90 go to step 144, and if from 106 go to step 148—step 142—go to step 74 FIG. 3B—step 144—go to step 92 FIG. 3 B—step 148—go to step 32 FIG. 3A

### TECHNICAL FIELD

The present invention relates to providing system proactively to web applications. This happens through the use of separate databases and interaction of with the client. One database is used to temporarily store information about the client's wants, needs and desires, thus creating the client's OV and the other database is used to store information about the value matrix of different venues located at different sites and locales or the different services and products that a company wants to offer.

### BACKGROUND

The expansion of the Internet and the World Wide Web has allowed goods and services to be projected to the word at large. There is no one in the industrialized world that does not know of, and few have not used, the Internet. Having reviewed the current state of user applications there is no system that is truly proactive in meeting the client's needs, wants or desires. At this time the client needs to know what he/she wants, and then needs to locate a web site that then offers the service/product/venue. Using this system, a client has a greater probability of selecting solutions that the client will have a good experience (enjoy.) Even when the provider is tapped into the client's purchasing database, the current state of affairs has providers providing advertising or offerings to their clients that may or may not relate to what the client truly wants or needs.

This system is similar to the date matching systems in use today in that we do utilize a basic personality study but there are 2 major differences between current date matching systems and this system, this system goes beyond matching just individuals and can be applied to groups and this system is applied to products, services and venues to the client instead of an individual client to an individual client. Thus this patent can allow new techniques such as reverse data-mining, where the product, service or venues are data-mined for application to a clients need, want or desire as opposed to the client's financial information being data-mined for a possible application of a product, service or venue. Reverse data-mining reduces costs to the providers, and thus to the providers clients in the long run.

This system allows the provider to identify the information that the client is interested in and respond with suitable offerings. Using travel systems as an example, current booking and travel web sites still require the client to know where they want to go. There is no method available to help the client know where it is that they want to go. This is normally a function of a traditional Travel Agent.

There is no true automated travel agent system, just booking and reservations systems with lots of advertising. Using the current tools available to the travel systems today, and this process, an automated travel agent is now possible. With this tool an Automated Banking/Investment system can be proactive with their client's wants and desires and make the appropriate offering to the client, conversely the brokerage houses can utilize this process to make sure that their clients are not being offered investment tools that are contrary to their goals and objectives.

The following paragraph is a brief history of the Airline booking industry to show an example of why this system is needed. Currently the airline industry is in the 5^{th} generation of system availability. 1^{st} generation was a filing system that was limited to 8 agents. 2^{nd} generation was the movement of the filing system to electrical means; they still needed 2 people for each reservation. 3^{rd} generation was the automated systems development that eliminated the need for a back room person to the booking process. SABRE would be a good example of this. The 4^{th} generation allowed the expansion of the system out of the airlines into travel agencies. The 5^{th} generation was the final expansion into the internet that allowed the industry to reach the entire global population. An argument could be made that the addition of Data-mining is another generation advance, but that only affects marketing and not how the product is delivered to the clients. This is where the whole Booking and Reservations industry has been stuck for over 10 years.

Coupled with this is the inability for users and the providers to quantify the concept of “Fun or Risk,” and other descriptive but, thus far, non-quantifiable “values.” For example, each of us knows what “Fun or Risk” is. We can communicate to one another that something or some venue was “Fun or Risky.” Thus far the ability to quantify “Fun or Risk” and compare it to other “Fun or Risky” venues has not been successful across non-common venues. One can compare Roller Coasters to other Roller Coasters but how does one compare the Roller Coaster to a National Park? This system is capable of doing this for an individual, a family, a group or an organization. This ability to quantify “Fun or Risk,” in reference to the venue, is what allows the system to function with the Travel Booking system. Other systems that require objective judgment can now be quantified as well.

This process has the ability to incorporate outside value systems in order to provide a more balanced and current evaluation of products, goods, services and venues. This is important because human beings are dynamic in their likes and dislikes, definitions of Acceptable and Risky, etc. being able to reflect these into a computer program via this process allows a company to stay current with today's fast paced world and remove a programmer's bias.

The ability to go beyond individual profiling is also a huge assist to all industries. Travel agencies have always dealt with families but the process is capable of going beyond handling small groups. Being able to handle organizations or parts of organizations allows companies to be able to evaluate specific parts of themselves, to make sure that the company is capable of providing the best goods, products or services to their clients. Any company with a client facing organization will see this advantage.

This ability to self-evaluate a company's client facing group's personality profile means that a company will know what sort of personality it is projecting to their clients on a consistent basis. It will also allow a company to understand how the individual parts, or people, within the organization make up that personality. Should the company decide that they want a different projected persona, the company could then understand what parts or people they need to change out, or shuffle around, in order to get to the desired personality profile that their clients would interface with on a consistent basis.

The ability to do reverse data mining will be a major cost savings to companies. Current data mining systems follows a specific production path. This starts with a company developing a specific demographic/economic profile that is then compared to individual purchasing databases. This data then goes to the company so it can advertise its goods, products, services or venues to specific clients. The current focus of data mining is to evaluate the individual purchasing database to predict future trends or purchases. Reverse data mining allows for the evaluation of the good, product, service or venue for comparison with a client's actual desires, wants or needs. This reduces the costs required to be expended with the credit companies. Since a company can only justify the expenditure of monies to the credit companies for a specific demographic/s that means that they are self limiting their markets and that not all of a population can be addressed. With reverse data mining the focus is not on the individual purchaser but on the good, product, service or venue. This means that the company can address their offerings to the entire population that can be serviced instead of a smaller sub-grouping that might want their offering.

A look at previous art in this area filed shows a lack of ability to handle 3 things: Grouping, External controls and Reverse Data-Mining. This patent provides us with the ability to group both the personal profiles of multiple persons as well as the grouping of profiles/attributes of the Products, Services and Venues. This patent can also incorporate External Standards, this means that personal bias can be removed and the recognition that a product, service or venue is a real premium as opposed to just marketing or advertising. Reverse data-mining shows that it is now possible to focus on the products, services or venues for delivery of something desired instead of focusing on the financial information of persons that have no connection to your company. This ability allows us, society, to remove 1 more level of intrusiveness into each other's personal business and focus on the cost effective delivery of products, goods and services.

### SUMMARY

One objective of the present invention is to allow the travel booking industry to offer to their clients different options that were not available to them earlier, such as an automated Travel Agent. Another objective is to allow Real Estate business systems the ability to provide automated Real Estate tools that are more attuned to their client's needs. This invention also allows better focus of an advertiser's dollar. This invention allows clients a better choice of options that they may not have known about. This invention goes beyond the Travel Booking or Real Estate aspect. This invention allows better proactively for all web systems that require humans to decide what it is that they want based on characteristics of a merchant's product, service or venue. This could be used for creating web-based Brokers and other web-based applications where a human would normally be used to interpret the client's needs, wants and desires. The process also allows for the automation of risk checking tools for companies as well as the ability to reverse data mine.

### BRIEF DESCRIPTION OF THE DRAWINGS

FIG. 1A is the start of the user profile flow process that allows for the use of grouping profiles should more than one (1) profile be required to make a decision. Should there be multiple profiles that need to be included in making a decision there are processes for these. Included in this process is for peers; a system should there be a priority amongst profiles; a combination of the two for a small group or a family set of profiles; and an organizational system should the group of decision makers have a more complex social decision making makeup.

FIG. 1B this process is for handling peer groups. Where all the individuals are seen as equals in there needs, wants and desires.

FIG. 1C this process is the hierarchical weighted system when the client wants to assign decision priorities to the group.

FIG. 1D is the complex weighting system that is more reflective of a family situation where the parents would be seen as equal partners, and sibling groups would make up other sub-groups. These groupings could then be assigned a specific number according to their priority ranking by the client.

FIG. 1E this is the organizational modeling process. This is used for organizations that have different sub-organizations within the larger organization itself. Each sub-organization is modeled within a larger organizational structure. After the separate organizational blocks have been arranged to the client's satisfaction, the individual profiles are assigned to the separate blocks so that system can generate an individual profile for the organization as a whole.

FIG. 1F this is the sub-grouping process that is best used with families but can be used with any grouping process. The process generates sub-groups, specifically for families with children, but can be used for other groupings as well. Grandparents with children or small organizational get-togethers would be a good example. Note: If excessively large groupings were resolved earlier, resolving sub-groups may cause excessive resource usage. It is recommended that there are limits to the number of profiles that will be part of a sub-grouping process.

FIG. 1G this is a “Brute Force” method of dealing with this issue, where large amounts of computing power is used to develop a result. This is not a desired method and is used sparingly.

FIG. 1H this is the user profile completion process. After the client has made arrangements to determine the final user profile, the client has a chance to develop sub-groups; The user is provided the results of the possible matches with their profiles as well as venue matches for sub-groupings, is requested; The process also allows for exiting the process to go to other parts of the clients existing web site.

FIG. I this is a process that can be used to group profiles based from a web list.

FIG. 2 this drawing is used to help the reader understand the reasoning behind how the organizational profile should be developed. Blocks within blocks, with each block either a peer or hierarchical block.

FIG. 3A starts the evaluation process for a VPS system with the option of having the ability to incorporate an outside measurement system incorporated into the flowchart. The process requires the setting of standards to be used for every VPS. These standards reflect the basic values of the VPS type and not a ranking of the VPS itself.

FIG. 3B shows a Complex Locale/Venue Evaluation process for a VPS system using the set of standards generated in FIG. 3A for every VPS. It allows for the detailed evaluation of VPSs that are made separate objects that could be considered to be a separate VPS themselves according to the standards generated earlier. This is most often seen with larger venue offerings like an amusement/theme park but sometimes goods, products and services can be part of a package that would have separate constituent parts.

FIG. 3C this process is the Outside Standards Process. This process is called to when ever the need to the use of the outside measurement is needed. Note that the standards referenced for the outside standards process were generated in FIG. 3A.

Table 1 an example of a simple rating standard. (Note: The actual standards table is expected to be much larger. This table is only for demonstration purposes)

Table 2 an example of a Locale, called Town A, using the sample rating standard in Table 1

### DETAILED DESCRIPTION

The following description is of the best mode presently contemplated for practicing the invention. The description is not to be taken in a limiting sense, but is made merely for the purpose of describing the general principles and processes of the invention. The scope of the invention should be ascertained with reference to the issued claims. The focus of this example is on a travel booking system in order to provide a better way for this process to be evaluated in an actual usage situation. This example is to be used as an example only and not meant to limit the usage of this process to other industries or applications.

The Analysis engine is a set of software driven programs that allows one to compare different databases. One database would be the profile of the client and the other would be the profile of the product, service or venues. The best matches, or closest percentage match, would be presented to the client.

A client would access the system (see FIG. 1A). The system would prompt the client for specific client information that would determine the client's interests, a personality review. This makes up the client's profile and goes into the temporary client database.

The temporary client database would include different values that would best represent the client's preferences. Similar to the client profiles utilized by the computer dating services, this program determines the client's basic needs, wants and desires. It is a personality profile. Different values would be generated for the client for such things, but not limited to, as: is the individual Adventurous vs. Sedentary; Age: young vs. Old; Tactile vs. non-tactile; Participatory vs. Observation; Aggressive vs. Passive; Science vs. Art; Hazardous vs. Safety; Scary vs. Humorous; and Adult theme vs. Family Friendly; Public vs. Private, Quite vs. Loud, Risk Adverse or Risk Acceptance; etc (the things that make up “Fun” and “Risk”), and Cost—What the client is willing to spend on the activity (optional).

These selections can be modified to best determine what it is the provider needs to understand about the client. For example the provider may be a Hardware Store or Real Estate Provider. In this case the profile would include categories for style and taste and would not need to include other categories. The provider may be a restaurant where cultural food types (French, Italian, etc) or romantic ambiance (Public vs. Private, and Loud vs. Quite) would/could be factors. These preferences would then allow the provider to better understand what it is the client actually wants and desires. Each of these categories would be ranked and assigned a numerical value that would then be stored in the temporary client database. The profile is then compared with the venue database for matching sets of interests.

Another advantage that this system allows is the derivation for a family, group or organization profile from the selection of the different individual profiles. This derivation can be done using a simple averaging technique, by hierarchical system, by a family weighing system or an organizational application using combinations of the averaging and hierarchical techniques to specific client profiles (called the OV). These techniques generate a unique profile (OV) for the client that can be compared to the Venue, Product, and Service (VPS) database.

For example, let's assume that the family is 5 individuals so the total number of the party is 5. A simple averaging technique (FIG. 1B) could be used to find out what the group wants if all members of the family are seen as having equal value as to their wants, needs and desires. If it is determined that there is a hierarchical value system for the family, as set by the client, i.e. Dad, Mom, eldest to youngest, then a hierarchical weighting system (FIG. 1C) can be used to determine the values for the family unit.

The hierarchical weighting system (see FIG. 1C) would be determined by allowing the client to determine the priority of the party members. The weight would then be the total number of the party and scale down as you go down the hierarchy. In that case the multiplier of 5 would be assigned to the priority party member (Dad); the multiplier of 4 would be assigned to the 2^{nd} highest priority member (Mom), etc. This would continue to the last party member.

The multiplier would then multiply the particular value that a client has. These values would then be added up and divided by the sum of the multipliers. If N=# of party members then the formula is divider=(N+(N−1)+(N−2)+(N−x) until N−x=0 where x is the decremented value of N. In our earlier example, the group of 5 would have a divider of 15 (5+4+3+2+1=15). The resulting values would be the group's profile. If the group were 8 then the divider would be 36 (8+7+6+5+4+3+2+1=36)

An example of this for the Travel Booking for a Father, Mother, 2 Sons and a baby girl, would be the following (using table 1):

| | | 1 | 2 | 3 | 4 | 5 |
|---|---|---|---|---|---|---|
| Category | | Dad | Mom | Son | Son | Daughter |
| Adventurous vs. Sedentary | AS | 8 | 6 | 9 | 8 | 3 |
| Age: young vs. Old | YO | 6 | 6 | 5 | 4 | 2 |
| Tactile vs. non-tactile | TN | 7 | 5 | 8 | 7 | 6 |
| Participatory vs. Observation | PO | 6 | 4 | 8 | 8 | 3 |
| Aggressive vs. Passive | AP | 6 | 3 | 6 | 4 | 2 |
| Science vs. Art | SA | 7 | 3 | 7 | 5 | 2 |
| Hazardous vs. Safety | HS | 5 | 3 | 8 | 6 | 1 |
| Scary vs. Humorous | SH | 6 | 2 | 8 | 8 | 1 |
| Adult theme vs. Family Friendly | XF | 6 | 4 | 1 | 1 | 1 |
| Risk Acceptance Vs Risk Adverse | RA | 6 | 5 | 7 | 8 | 3 |
| Cost | CO (optional) | | | | | |

Simple averages

| | | | | | | | | | | | | | | | | | | | | |
|---|---|---|---|---|---|---|---|---|---|---|---|---|---|---|---|---|---|---|---|---|
| Totals | AS | 34 | YO | 23 | TN | 33 | PO | 29 | AP | 21 | SA | 24 | HS | 23 | SH | 25 | XF | 13 | RA | 29 |
| Group average | AS | 6.8 | YO | 4.6 | TN | 6.6 | PO | 5.8 | AP | 4.2 | SA | 4.8 | HS | 4.6 | SH | 5 | XF | 2.6 | RA | 5.8 |
| Weighted | AS | 110 | YO | 79 | TN | 99 | PO | 89 | AP | 70 | SA | 80 | HS | 74 | SH | 79 | XF | 52 | RA | 90 |
| Totals | | | | | | | | | | | | | | | | | | | | |
| Weighted | AS | 7.3 | YO | 5.2 | TN | 6.6 | PO | 5.9 | AP | 4.6 | SA | 5.3 | HS | 4.9 | SH | 5.2 | XF | 3.5 | RA | 6 |
| Average | | | | | | | | | | | | | | | | | | | | |

Family weighing (see FIG. 3) is more complicated. This is actually a subset of the organizational process (FIG. 1E) that is particularly useful with family settings where the parents are grouped together and seen as equals as to where and what they want to do/see/experience and separate groups for the children who can be broken down to even smaller groups as required. It requires the client to equate individuals within the grouping. The internal individuals within the groupings are averaged as they are seen as equals. The groups seen as hierarchical and are assigned appropriate weights. The totals for the separate groups are developed and they are divided according to the number of groupings there are. For example a family of 8 accesses the system. Mom and Dad are considered 1 group, oldest son and daughter are the 2^{nd} group, the next 3 kids are the 3^{rd} group and the baby is the last group (4).

| | | 1 | 2 | 3 | 4 | 5 | 6 | 7 | 8 |
|---|---|---|---|---|---|---|---|---|---|
| Category | | Dad | Mom | Son | Daughter | Daughter | Son | Son | Daughter |
| Adventurous vs. Sedentary | AS | 8 | 6 | 9 | 8 | 6 | 6 | 6 | 2 |
| Age: young vs. Old | YO | 6 | 6 | 5 | 4 | 4 | 4 | 4 | 1 |
| Tactile vs. non-tactile | TN | 7 | 5 | 8 | 7 | 5 | 5 | 5 | 5 |
| Participatory vs. Observation | PO | 6 | 4 | 8 | 8 | 5 | 7 | 7 | 2 |
| Aggressive vs. Passive | AP | 6 | 3 | 6 | 4 | 2 | 5 | 7 | 1 |
| Science vs. Art | SA | 7 | 3 | 7 | 5 | 5 | 5 | 5 | 1 |
| Hazardous vs. Safety | HS | 5 | 3 | 8 | 6 | 3 | 6 | 6 | 1 |
| Scary vs. Humorous | SH | 6 | 2 | 8 | 8 | 2 | 5 | 6 | 1 |
| Adult theme vs. | XF | 6 | 4 | 3 | 1 | 1 | 1 | 1 | 1 |
| Family Friendly | | | | | | | | | |
| Risk Acceptance vs. | RA 6 | 5 | 7 | 4 | 3 | 8 | 5 | 1 | 1 |
| Risk Avoidance | | | | | | | | | |

| Group averages | AS | YO | TN | PO | AP | SA | HS | SH | XF | RA |
|---|---|---|---|---|---|---|---|---|---|---|
| 1 | 7 | 6 | 6 | 5 | 4.5 | 5 | 4 | 4 | 5 | 5.5 |
| 2 | 8.5 | 4.5 | 7.5 | 8 | 5 | 6 | 7 | 8 | 2 | 5.5 |
| 3 | 6 | 4 | 5 | 6.3 | 4.6 | 5 | 5 | 4.3 | 1 | 5.3 |
| 4 | 3 | 2 | 6 | 3 | 2 | 2 | 1 | 1 | 1 | 1 |

Therefore AS=(7*4)+(8.5*3)+(6*2)+(3*1)=68.5 68.5/10=6.9
(6*4)+(4.5*3)+(4*2)+(2*1)=47.5 47.5/14.8

etc. . . .

Weighted group totals AS 68.5 YO 47.5 TN 62.5 PO 59.6 AP 44.2 SA 50 HS 48 SH 49.6 XF 29 RA 50.1

This will be divided by 10 (4+3+2+1=10). Using this sort of system allows the user to determine the complexity of their group and the resulting group profile. This process allows the system to be flexible for the user. Determining the default method of defining grouping would be up to the provider.

The last part of the profiling process allows for the creation of an organizational profile (FIG. 1 E). The organizational profile allows for the creation of an overall organizational management structural block (FIG. 2). This is either a Peer (averaging) or a Hierarchical block. Then smaller peer or hierarchical blocks are placed within the organizational structural block. These building blocks are generated to represent the organizational structure as it is, or if modeling, as one would like it to be. Then individual profiles are placed within the different blocks. Once that has been completed then the system goes through its processes to generate a complete organizational profile. This can be particularly useful for a company that wants to evaluate its client facing operations or how different members of an organization can work with each other to generate a more effective and efficient organization when setting up work for specific projects or contracts.

As part of the final profile part of the process the system can generate sub-groupings (FIG. 1F), or micro-groups, for groups. This would be helpful for families who want to spend quality time for specific parings of the two parents, parent and a child, or group of children. These are matched against specific venues at a locale.

As part of the profile completion process (FIG. 1H) the client's OV Profile is compared against the Product, Service, Venue (PVS) database and the best matches are offered in order for selection by the client. It is possible that during this process that the system could come across a possibility that a couple of locales or venues could end up having the same or very closely the same OV values and the system would have a problem deciding which one to offer 1^{st}. To help over come this problem we could utilise a simple Brute Force (Figure G) evaluation technique.

This could be run against the entire database but it would not be as efficient as if it was run against just those locales or venues that are in conflict. The brute force system technique would more effective evaluating each attraction and venue for a specific match, or very close match (a percentage to be designated by the provider), to the designated OV profile value or the group of OV profiles (if a group). Because the nature of the Brute Force technique requires the extended use of resources it is recommended that the presentation of equal OV profiles be made in a system define manner such a alphabetically, closest 1^{st} match etc.

It should be noted that when a brute force technique is used then we run up against a problem with ages. This is because there is little difference between 34 and 36 year olds but a huge difference between 3 and 6 year olds. This means a difference of 10% will not work for age. When Brute Force is used age should be evaluated in blocks as each of these blocks have something specifically unique about their particular group. Something like the following:

0-6 months

6 months to 1 year

1-2 year

2-3 year

4-6 year

6-8 year

8-10 year

10-13 year

13-16 year

17-18 year

18-21 year

21-30 year

30-45 year

45-60 year

60-75 year

75+

There are other ways to handle groupings. One way that works well with small groups and on the internet is to allow someone to enter the names of the people in the group in a priority order. Except for the name each time a new name is entered the user is either prompted or asked to check a block if the new name is a peer to the person just listed earlier. This sets up a priority of groups and peers. If a peer prompt is not affirmed, or the peer check box not checked, then a new group is established and a new set of peers can be created. (See FIG. 1I)

Another way of handling this is to just allow the user to enter the names and the priority at the same time or to allow them to set the priority after they have entered the names. With this idea it would be possible to treat the groups that have the same priority as peers, the priority levels could also be broken down into sub-groupings by using alphanumerics as well. Using the alphanumeric system also allows a command line creation of a larger organizational group instead of a web based block form, but the logic may be more difficult to understand by a user. (FIG. 1I can still be used in this situation but you would begin at step 320.)

Using the ticking booking system as an example the client has selected the local and then they are offered a chance to select sub-groupings. A sub-grouping a normally a coupling of a primary group member (Mom or Dad) with a secondary group member (a child). These sub-groupings would then be compared against the PVS database for specific venues that would best match the sub-groupings and these would also be offered to the client. Compare how families normally operate on vacation. It is common for a family to break up temporally, Mom may take a son(s) or daughter(s) as well as Dad and that couples/groups will go off to do something together. It is also common that the parents will focus on what it is that the child (member of the secondary group) wants to do. Therefore the sub-grouping process allows for the setting of weights for the members of the sub-groups. After the matches with the venues are made the client is sent to other parts of the provider's web site to make the necessary arrangements for going to these locales, getting tickets for specific venues, or start to make the necessary plans to go to the destination of their choice.

This next part of the process is what allows you to rate “Fun or Risk and other, previously non-quantifiable human values.” We apply an observable profile from a set of standards, which are similar to the personality profiles requested of our clients, to an object, service or venue. From this set of standards a PVS database is developed and you can derive what is meaningful and of value to the individual or the group when the personality profile is compared to the PVS database. Thus you can derive goods, products, services and venues that the client would identify with.

The second database is owned by the vendors or providers. There are at least 3 ways to accomplish products, services, and venue/vendor grading. A simple system is where an internal standard is used to grade a venue, product or service in relation to the personality traits being sought from the client. This means that all products, services or venues of the same type have the same values. A complex system is where a venue/product or service is the sum of its internal component constituents. The third system allows for modification of the standards according to a provider recognized outside grading system. An example of this would be an inclusion to the standards a variable that references an International comparison of Roller Coasters. Amusement parks with Roller Coasters that have a high rating should have a different OV value of an amusement park without a highly rated Roller Coaster or Coasters. Even the amusement parks themselves have external ratings that can be included. Using any of these systems will require that a standard must be kept to in order to make sure that these venue ratings were stable. The same could be said of 4 and 5 star restaurants or resorts. This allows for the addition of “value added” to a product, service or a venue so long as that “added value” is from a recognized, objective outside source from that which is being graded. This helps separate advertisement claims from reality.

Using the standards developed by the manufacture or provider, you can rate the type of “Fun or Risk”. One can rate how good the “Fun or Risk” is by looking at the participation rates but that can be affected by the size of the local population at the venue so small venues can be adversely affected by using this as a standard. By using a set of developed standards for a common set of products, services or venues we can avoid this trap and using participation rates is really not required for a simple system (see FIG. 3A). What is required for the system is recognition of the types of products, services or venues and the type of “Fun or Risk” offered. Therefore a simple standard per product, venue or service is required and assigned per venue or service at the locale or service.

### Simple Locale or Service Rating System

7) Decide on a specific standard for each type of product, service or venue that should be encountered.
8) Choose a specific locale, global set of products, or services that you want to rate.
9) Determine all the products, services or venues available within the global selection set.
10) Rate the venues or services according to the standard already developed.
11) Total and place in the database the specific ratings.
12) These are now the locale, product or service profile that can be used to compare against the client's profile.

### Example:

Attractions and venues would need to be evaluated according the following criteria to determine how much “Fun” it may have (Note: this list is not to be considered to be complete, this is to be used as an example only):

| | |
|---|---|
| Adventurous vs. Sedentary | AS |
| Age: young vs. Old | YO |
| Tactile vs. non-tactile | TN |
| Participatory vs. Observation | PO |
| Aggressive vs. Passive | AP |
| Science vs. Art | SA |
| Hazardous vs. Safety | HS |
| Scary vs. Humorous | SH |
| Adult theme vs. Family Friendly | XF |
| Risk Adverse vs. Risk Acceptance | RA |
| Daily vs. Annual | DA (optional multiplier or |
| | seasonal addition/subtraction) |
| Cost | CO (Optional) |
| (See Table 1) | |

An example of how a locale or community can be rated can be seen in Table 2. With a simple averaging system the OV can be determined. For our example Locale (from Table 2) we get the following Average OV matrix value:

Locale Profile average AS 6.4 YO 4.8 TN 5.7 PO 7.4 AP 5.3 SA 4.6 HS 5.0 SH 5.4 XF 3.7 RA 2.9

### Complex System

Of the Towns venues, the Amusement park can be broken down further. There are multiple components, or venues, within the amusement park (see FIG. 3B). Therefore the different components of the amusement park can be evaluated and a composite OV matrix can be determined. So the following would be true for these venues, (Note: in Beta testing it was determined that keeping the values of fast food and family restaurants can dilute the results. It is recommended that these be left out of the equation else almost all locations end up reflecting the total number of fast-food/family restaurants in the location):

Amusement Parks

| | | | | | | | | | | | | | | | | | | | | | | | |
|---|---|---|---|---|---|---|---|---|---|---|---|---|---|---|---|---|---|---|---|---|---|---|---|
| 1 | Water | AS | 9 | YO | 8 | TN | 8 | PO | 9 | AP | 8 | SA | 5 | HS | 7 | SH | 7 | XF | 6 | RA | 6 | DA | 1.0 |

Water Park:

| | | | | | | | | | | | | | | | | | | | | | | | |
|---|---|---|---|---|---|---|---|---|---|---|---|---|---|---|---|---|---|---|---|---|---|---|---|
| 5 | Water | AS | 9 | YO | 8 | TN | 8 | PO | 9 | AP | 8 | SA | 5 | HS | 7 | SH | 7 | XF | 6 | RA | 7 | DA | 1.0 |
| | Slides | | | | | | | | | | | | | | | | | | | | | | |
| 1 | Wave | AS | 6 | YO | 5 | TN | 8 | PO | 8 | AP | 5 | SA | 4 | HS | 5 | SH | 5 | XF | 6 | RA | 5 | DA | 1.0 |
| | Pool | | | | | | | | | | | | | | | | | | | | | | |
| 1 | Lazy | AS | 3 | YO | 6 | TN | 8 | PO | 8 | AP | 3 | SA | 3 | HS | 2 | SH | 2 | XF | 6 | RA | 2 | DA | 1.0 |
| | River | | | | | | | | | | | | | | | | | | | | | | |
| 1 | 4 Star | AS | 5 | YO | 5 | TN | 8 | PO | 7 | AP | 2 | SA | 6 | HS | 8 | SH | 5 | XF | 7 | RA | 2 | DA | 1.0 |
| | Res- | | | | | | | | | | | | | | | | | | | | | | |
| | taurant | | | | | | | | | | | | | | | | | | | | | | |

| | | | | | | | | | | | | | | | | | | | | | | |
|---|---|---|---|---|---|---|---|---|---|---|---|---|---|---|---|---|---|---|---|---|---|---|
| Combined | AS | 59 | YO | 56 | TN | 64 | PO | 66 | AP | 42 | SA | 38 | HS | 50 | SH | 47 | XF | 49 | RA | 44 | DA | 10.0 |
| totals | | | | | | | | | | | | | | | | | | | | | | |
| Combined | AS | 7.4 | YO | 7.0 | TN | 8.0 | PO | 8.5 | AP | 5.3 | SA | 4.8 | HS | 6.3 | SH | 5.9 | XF | 6.1 | RA | 5.5 | | |
| Average | | | | | | | | | | | | | | | | | | | | | | |

Replacing the new values for the amusement park would yield the following OV for the locale:

Totals AS 388.4 YO 294 TN 346 PO 452.5 AP 323.3 SA 283.8 HS 306.3 SH 325.9 XF 226.1 RA 174.5

Total venues 61

Complex Local Profile AS 6.4 YO 4.8 TN 5.7 PO 7.4 AP 5.3 SA 4.7 HS 5.0 SH 5.4 XF 3.7 RA 2.9

### Modified Complex Locale Rating System

Outside of just assigning a group of venues as specific set of standards, a particular type of venue could be assigned a standard set with a variable allowance (see FIG. 3C) if there is a set of common standards that have already been accepted (i.e. Roller Coasters, Restaurant ratings, etc.). Then each individual business within the venue could be rated separately, instead of collectively. The result would be combined just as it was done in the Complex Locale Rating System. The variable would be judged by using an outside set of standards. An example of this would be the International Rollercoaster rating system, the hoteliers rating system, independent restaurant rating systems. These variables would then be applied to the standard.

Using this type of standard system the providers can become as detailed as they want. For example, the travel system can go from rating a locale from just the type of venue with common standards, to rating the venue itself incorporating all its various components, to including an accepted, outside standard measure or a combination of these.

There are 4 ways to incorporate outside standards:
5) Use a multiple
6) Allow for increases/decreases for separate matrices
7) Attach a flag to the attraction that lets the system know that this is a premium/top attraction
8) A combination of the previous 3.

Advantages/disadvantages of these 3 methods are:
5) The advantage to using the multiple is that it has a better chance of affecting the venue's overall metric. The disadvantage is that the multiple can also change the metric in such a way as to make the attraction's profile not reflect a more realistic representation of the venue itself.
6) Changing specific matrices within the attraction metric may better represent the attraction but may not affect the venue's profile greatly.
7) If we add a specific flag noting that the attraction is seen as being noted as being special can allow the venue to be highlighted to the user during the user profile, venue matching phase but will not affect the venue's profile at all.
8) Combining adding a flag and changing specific matrix for the attraction would be the best way to handle this as it allows for the change in the matrix that better reflects the value of the venue and flags the attraction, venue, or locale for specific notice of the client later on as something special.

A demonstration of this would be a 4 star restaurant with a common standard of:

AS 5 YO 5 TN 8 PO 7 AP 2 SA 6 HS 8 SH 5 XF 7 RA 2 DA 1.0

with a variable of plus or minus 2 per standard because of the inclusion of an acceptable outside standard. For this demonstration we will assume several of the restaurants at the site have an international rating and a top Chef. There can now be an argument to increase the rating of the 4 Star restaurants to:

AS 7 YO 7 TN 8 PO 8 AP 4 SA 4 HS 8 SH 5 XF 7 RA 2 DA 1.0. and setting a premium flag for the restaurant. This would be entered into the system and incorporated into the overall rating of the locale.

Using the previous example (see Table 2, page 33) suppose that the small community decided to use the process and decided to focus on tourism, to accomplish this goal they were able to work with local businessmen and brought in top chefs for their restaurants and now these restaurants were ranked nationally; they decided to promote the cultural aspect of their local carnival/fair and were now recognized in the nation as being a great place to go to; and the town was lucky enough to be located next to one of the nations best national Parks/Forests.

Dining

| | | | | | | | | | | | | | | | | | | | | | | | |
|---|---|---|---|---|---|---|---|---|---|---|---|---|---|---|---|---|---|---|---|---|---|---|---|
| 1 | 5 Star | AS | 2 | YO | 6 | TN | 9 | PO | 8 | AP | 2 | SA | 7 | HS | 8 | SH | 5 | XF | 8 | RA | 2 | DA | 1.0 |
| 3 | 4 Star | AS | 5 | YO | 5 | TN | 8 | PO | 7 | AP | 2 | SA | 6 | HS | 8 | SH | 5 | XF | 7 | RA | 2 | DA | 1.0 |

Is now changed to
Dining

| | | | | | | | | | | | | | | | | | | | | | | | |
|---|---|---|---|---|---|---|---|---|---|---|---|---|---|---|---|---|---|---|---|---|---|---|---|
| 1 | 5 Star | AS | 4 | YO | 7 | TN | 9 | PO | 8 | AP | 4 | SA | 9 | HS | 8 | SH | 5 | XF | 8 | RA | 2 | DA | 1.0 |
| 3 | 4 Star | AS | 7 | YO | 6 | TN | 8 | PO | 7 | AP | 4 | SA | 7 | SH | 8 | SH | 5 | XF | 7 | RA | 2 | DA | 1.0 |

Amusement Parks

| | | | | | | | | | | | | | | | | | | | | | | | |
|---|---|---|---|---|---|---|---|---|---|---|---|---|---|---|---|---|---|---|---|---|---|---|---|
| 1 | Carnivals | AS | 6 | YO | 5 | TN | 7 | PO | 7 | AP | 7 | SA | 5 | HS | 6 | SH | 6 | XF | 2 | RA | 5 | DA | .1 |

Is now changed to

| | | | | | | | | | | | | | | | | | | | | | | | |
|---|---|---|---|---|---|---|---|---|---|---|---|---|---|---|---|---|---|---|---|---|---|---|---|
| 1 | Carnivals | AS | 8 | YO | 5 | TN | 8 | PO | 8 | AP | 7 | SA | 7 | HS | 4 | SH | 5 | XF | 2 | RA | 5 | DA | .1 |

Parks

| | | | | | | | | | | | | | | | | | | | | | | | |
|---|---|---|---|---|---|---|---|---|---|---|---|---|---|---|---|---|---|---|---|---|---|---|---|
| 1 | Federal | AS | 6 | YO | 5 | TN | 6 | PO | 7 | AP | 5 | SA | 6 | HS | 6 | SH | 5 | XF | 6 | RA | 4 | DA | 1.0 |
| 1 | State | AS | 6 | YO | 5 | TN | 6 | PO | 7 | AP | 5 | SA | 6 | HS | 6 | SH | 5 | XF | 6 | RA | 4 | DA | 1.0 |
| 3 | Local | AS | 6 | YO | 5 | TN | 6 | PO | 7 | AP | 5 | SA | 6 | HS | 6 | SH | 5 | XF | 6 | RA | 3 | DA | 1.0 |
| 1 | Lake | AS | 6 | YO | 4 | TN | 7 | PO | 8 | AP | 6 | SA | 5 | HS | 6 | SH | 5 | XF | 7 | RA | 4 | DA | 1.0 |
| 3 | Trails | AS | 8 | YO | 4 | TN | 7 | PO | 9 | AP | 6 | SA | 5 | HS | 6 | SH | 5 | XF | 5 | RA | 3 | DA | 1.0 |

Is now changed to

| | | | | | | | | | | | | | | | | | | | | | | | |
|---|---|---|---|---|---|---|---|---|---|---|---|---|---|---|---|---|---|---|---|---|---|---|---|
| 1 | Federal | AS | 7 | YO | 5 | TN | 6 | PO | 8 | AP | 6 | SA | 4 | HS | 4 | SH | 5 | XF | 4 | RA | 4 | DA | 1.0 |
| 1 | State | AS | 6 | YO | 5 | TN | 6 | PO | 7 | AP | 5 | SA | 6 | HS | 6 | SH | 5 | XF | 6 | RA | 4 | DA | 1.0 |
| 3 | Local | AS | 6 | YO | 5 | TN | 6 | PO | 7 | AP | 5 | SA | 6 | HS | 6 | SH | 5 | XF | 6 | RA | 3 | DA | 1.0 |
| 1 | Lake | AS | 6 | YO | 4 | TN | 7 | PO | 8 | AP | 6 | SA | 5 | HS | 6 | SH | 5 | XF | 7 | RA | 4 | DA | 1.0 |
| 1 | Trails | AS | 6 | YO | 5 | TN | 7 | PO | 9 | AP | 5 | SA | 5 | HS | 5 | SH | 5 | XF | 5 | RA | 2 | DA | 1.0 |
| 2 | Trails | AS | 8 | YO | 4 | TN | 7 | PO | 9 | AP | 6 | SA | 5 | HS | 6 | SH | 5 | XF | 5 | RA | 3 | DA | 1.0 |

This changes the totals for the locale to:

Totals AS 397.4 YO 299 TN 347 PO 462.5 AP 331.3 SA 288.8 HS 300.3 SH 324.9 XF 224.1 RA 173.5

Total venues 61

Modified Complex Local Profile AS 6.5 YO 4.9 TN 5.7 PO 7.6 AP 5.4 SA 4.7 HS 4.9 SH 5.3 XF 3.7 RA 2.8

A comparison of the 3 yields:

Average Local Profile AS 6.4 YO 4.8 TN 5.7 PO 7.4 AP 5.3 SA 4.6 HS 5.0 SH 5.4 XF 3.7 RA 2.9

Complex Local Profile AS 6.4 YO 4.8 TN 5.7 PO 7.4 AP 5.3 SA 4.7 HS 5.0 SH 5.4 XF 3.7 RA 2.9

Modified Complex Local Profile AS 6.5 YO 4.9 TN 5.7 PO 7.6 AP 5.4 SA 4.7 HS 4.9 SH 5.3 XF 3.7 RA 2.8

Once the system has been driven down into a very detailed level then other things can now start to happen. Once a very fine point of detail the level has been reached, then amusement park planners can now start to design their parks with specific demographics in mind. They will start combining the specific rides, restaurants and other amusements to reach a specific OV profile. This same sort of detail will also allow city planners to allocate space in the community to different venues so as to give the city a specific OV profile.

Once a certain point of detail has been reached, then the consumer can also drill down into the local level as well. The clients can then look at the community and see what venue specifically meets his/her/or the groups profile the best. A matching profile has the best chance of being a venue that the client will enjoy. Then the client has the best chance to arrange his/her/or the group's time to be the most effective use of their limited time budget. Now the consumer can start to identify specific itineraries for their family, or even break up the family unit during different parts of the plan so that Mom and the kids, dad and the kids, or just the kids have a specific plan of action for a specific day.

Automated Real Estate services were mentioned in the abstract. Currently, Real Estate tools assist the agent in identifying the basics of what the client wants. The tools focus on the basic physical aspects of the client's desired home such as distance from work, single or multiple story, etc. . . . These tools are not able to focus on other qualities such as how a neighborhood might fit into the client's family's personality or dynamic. A good agent will be able to know these things about the neighborhood and be able to enter these dynamics into the system. Matching the Client's OV to a specific neighborhood or neighborhoods would allow the agent to focus the client there; this would be particularly helpful if the agent has not gone through that particular neighborhood. It would also allow a client to utilize remote Real Estate software from home much more effectively. This would be particularly true for those clients who are going to be relocated from one city to another. It could be envisioned that utilizing this sort of software along with another tool web tool that allows you to view street locations from a web map (i.e. Google's Street view tool) a consumer could then actually buy the home before they ever get to the new location. This will speed up the process for the Real Estate agencies and get a match between home buyer and home seller sooner. Allowing a better level of client interface with the automated tool at the beginning of the Real Estate search will speed up everything and it is the rate of house purchases that quickens the local economy.

Using the process as a tool to monitor brokers has been discussed. A client's profile can be matched against what products that they currently have and what is going to be offered. If a manager sees that one of his/her staff is going to offer, or has offered, a product that would be detrimental to the client's goals/desires. The system would be able to flag that transaction for management review. As most mangers have not had a chance to meet with the client, this tool would give them a chance to understand what a client's real goal is and prevent losses to a client, and the resulting law suites that follow. This will assist the Brokerage Firm in determining when a broker gets more involved with making a profit for themselves as opposed to making a profit for their client.

Products and services have been discussed. A company can start to look at their suite of products and services utilizing the process that this patent has expanded upon and then decide what type of individual would be best at utilizing their product or service. A set of standards can then be attached to each product. The company's clients can then be shown those products and services that this process shows that they most identify with first. Thus the client has a better chance of seeing a need for the product or service, thus providing the incentive to make a purchase. This would be of particular interest in identifying gifts to other individuals.

By means of this invention the various web applications can now become proactive with their clients in a way that was not available to them earlier. If the provider can become proactive with their clients then the provider has a better chance of being able to service the client in a way that the client will enjoy and the client will come back at a later date for repeat business. By incorporating the personality profile into the business plan instead of just the client's buying patterns the company can now tie into the client's desires as well as the client's needs and wants. The client can now expect to be offered options that they had not thought of before. Once communities reach this sort of detailed profile, the community planners can start to offer their community services to their own people in a way that their community wants. The community can start to plan for people wants and desires and not just for their current needs. Communities that focus on tourism can decide that a particular venue may not provide the proper sort of profile that they want and could encourage business to develop the venue that they do want. Communities that want to focus on specific businesses can use this process to make the necessary changes to their structure to make their communities more desirable. This invention is an advantage to business, clients and to communities.

### Step-by-Step Process Description

There are 2 Main processes. The first is for developing the user/group profile process the second is for developing the service/product/venue process.

### User/Group Profile Process

FIG. 1A Step 2—User access the system via World Wide Web—Step 4—User is asked to generate a user profile—Step 6 the user profile is stored in the temporary user database (it is normally counter productive to permanently store the user profiles)—Step 8—User is asked if they are profiling an individual (go to step 14) or a family/group (go to step 10)—step 10—the user is asked if more profiles are needed for the family/group, if more profiles are needed go to step 4 if not proceed to—step 12—User defines what sort of group/family that they have, the user has 4 choices, (1) simple averaging for the situation where all members of the group/family are seen as equals, go to step 30 Process A; (2) Hierarchy weighted where a group/family is prioritized highest to lowest. The higher the priority, the greater weight that profile has in determining the group profile, go to step 60 process B; (3) Family system, this a complex weight system, this allows a user to form groups that can have multiple individuals within them, the groups themselves are prioritized go to step 90 Process C; (4) Organizational Weighting system. This has been developed for the use of complex organizations that integrate the previous forms of organization within 1 overall structure. This allows the user to set up organizational blocks within organizational blocks and allows the system to relate the organizational blocks themselves as if they were individual profiles go to step 140—step 14—Provide the user with the profile result, this allows the user to see what the results were for the grouping processes (steps 38, 84, 130 and 176) and as a way for the user to verify the profile that they provided earlier if they are single—step 16—Does the profile match what the client was expecting? If no go back to start, step 2; if yes go to step 18—go to step 270 the User Profile Completion Process

FIG. 1B Step 30 Process A used when the group are peers—Step 32—Profiles are averaged together—step 34—the result of the averaging in step 32 is the profile composite—step 36—is the resulting profile for a peer group go to step 38, family profile go to step 40 or part of an Organizational profile go to step 42—step 38—provide results to user process (FIG. 1A step 14)—step 40—provide results to the family weighting process (FIG. 1D step 106)—step 42—provide the results to the Organizational process (FIG. 1E step 158)

FIG. 1C step 60—This is the Hierarchy weighting process that is used when the group members are to be considered to have a hierarchy and that their profiles should reflect the hierarchy. This process can be used for a simple group or as part of a larger complex organizational process—step 62—total the number of user profiles in the group. Assign this number to the variable u and to constant N—step 64—User decides the user profile priority, or hierarchy. The 1^{st} person of the list has the highest priority and is designated the Priority user—step 66—Does the priority user have an assigned weight of 1? if not proceed to step 68, if the priority user has an assigned weight of 1 go to step 74—step 68—Assign priority user the assigned weight of u—step 70—decrement variable u by 1—step 72—go to the next name on the list, that person is designated the priority user, if there are no more names on the list that last person stays as the priority user, go to step 66—step 74—Multiply the user profiles by the assigned weight—step 76—add all profiles—step 78—Divide the user profiles by the formula: N+(N−1)+(N−2)+ . . . +1—step 80—the result of this number is called the composite profile—step 82—Is this a user/group profile go to step 84, or an organizational profile go to step 86—step 84—provide results to user process (FIG. 1A step 14)—step 86 provide results to Operational group (FIG. 1E step 158)

FIG. 1D step 90—The family grouping system is a complex system that allows one to organize a hierarchy of groups. These groups can be made up of 1 or more individuals. The individuals within the groups are seen as peers. This sort of arrangement is very effective with family groups where it is often seen that Mom and Dad are the priority group and there can be multiple secondary groupings made up of the younger children in the family. This can also be used for small organizations, or groups within a larger organization—step 92—User specifies how many groups there will be—step 94—Assign the total number of groups to variable g and to constant M—step 96—user places the individuals in each group from the profiles that the user has already created from steps 4 thru 10—step 98—User decides the group priority, or hierarchy and lists them—step 100—Do all of the groups in the group list have a composite weight? If yes go to step 114, if no go to step 102—step 102—go to the top of the group list—step 104—Is there more than profile in the group? If yes go to step 106, if no go to step 108—step 106—pass all profiles in the group to process A, FIG. 1B step 30—step 108—this is the composite profile, data from process A step 40 can be inputted as the composite profile if there was more than 1 member from that group—step 110—is this the last group in the list? If yes go to step 114, if no go to step 112—step 112—go to the next group in the group list, go to step 104—step 114—Go to the top of the group list, the 1^{st} group is designated the priority group—step 116—Does the priority group have an assigned weight? If yes go to step 122, if no go to step 118—step 118—Assign the priority group the assigned weight of g—step 119—decrement g by 1—step 120—step down the group list, this next group now becomes the priority group, if the group is the last on the list it will remain the priority group, go to step 116—step 122—Multiply the profiles by the assigned group weight—step 124—add all the profiles—step 126—Divide the user profiles using the formula M+(M−1)+(M−2)+ . . . +1—step 128 the result is the final composite profile for the family—step 130—provide the final composite profile to the user process (FIG. 1A step 14)

FIG. 1E step 140—Organizational process, this is used for larger organizations or for internal parts of larger organizations—step 142—User choose a Hierarchy or a Peer building block for the organizations overall management structure, this is the organizational block—step 144—User then populates the Management block with Hierarchy and Peer building blocks to reflect the actual organizations structure—step 146—the system generates an initial diagram/list of upper level blocks for the user to review—step 148—User makes changes, if required, to the diagram/list—step 150—User populates all the building blocks with the user profiles that were generated in steps 4 thru 10—step 152—System examines the first block on the list—step 154—Check to see if there is a building block without a composite profile within the current building block, if yes go to step 156, if no go to step 158—step 156—go to the unresolved block, proceed to step 154, this is a looping process because you can have multiple blocks within blocks when organizations are built. While an organizations goal may to flatten out its structure as much as possible, due to budget, legal, or other restrictions that may not be possible. The purpose of this loop is to get to the bottom most block without a composite profile—step 158—examine block profile, accept data from process A (peer step 42) and process B (Hierarchy process step 86)—step 160—Does the profile represent the organizational block? If yes go to step 172, if no go to step 162—step 162—has the block profile been resolved? If yes go to step 164, if no go to step 166—step 164—go up 1 level on the block list, go to step 154—step 166—is this a Peer or Hierarchy group? If Peer go to step 168, if Hierarchy go to step 170—step 168—provide profiles to process A step 30—step 170—provide profiles to process B step 60—step 172—Has the Organizational Profile been resolved? If yes go to step 176, if no go to step 174—step 174—go to next group on the group list, go to step 154—step 176—provide the composite profile to the user process FIG. 1A step 14

FIG. 1F step 180—Sub-grouping process, this process was developed when we recognized that most families try to set up some sort of quality time with different members of the family separate from the larger family group. Normally this is 1-on-1 time between the mother-child and father-child. This can also be used for small organization teams as well. Most often this is seen with management team retreats—Step 182—User is asked to identify the primary users Mom & Dad, Sr. Management, etc. the total number of primary users is stored as a constant [P] to be used later on—step 184—User is asked to identify the secondary users (kids), lower management level members, the total number of secondary users is stored as a constant [S] to be used later—step 186—the individual user profiles that were generated earlier in steps 4 thru 10 are pulled out of the temporary database for use—step 188—User decides if they want the system to use default weights (X=1, p=X, s=2X) go to step 190 or does the user want to define the weights themselves go to step 192—step 190—system needs an input from the user as to how large the sub-groups will be, this number is stored as constant N —step 192—user designates the weights for Primary and secondary group X, p and s—step 194—Will the system or the user generate the sub-groupings, if system go to step 196, if user go to step 200—step 196—system generates multiple sub-groupings consisting of 1 Primary group member and (N−1) members of the secondary group, NOTE: A limit to the size of the maximum group should be considered as the processing of innumerable sub-groups can put a major drain on the system and could become a point for a DoS attack—step 198—Have all combinations for Primary and Secondary users been made? If yes go to step 204, if no go back to step 196—step 200—User identifies and selects the sub-groups, the size of the subgroup is totaled and stored as constant R1, R2 . . . —step 202—is another sub-group needed, if yes go to step 200, if no go to step 204—system generates the sub-group of all the Primaries, Mom and Dad need alone time as well—step 206—system assigns weights s and p depending if the profile was a primary or a secondary profile—step 208—System multiplies all profiles by their designated assigned weight—step 210—Primary and Secondary profiles are added together within the sub-group—step 212—Combined sub-group profile is divided by the formula (p+s1+s2+ . . . +sx)—step 214—Separate sub-group profiles are compared against the venues at the Locale selected—step 216—provide results to User Profile Completion Process FIG. 1H step 288

FIG. 1G step 220—Brute Force process—step 222—Get user profiles from the temporary user database—concurrently do steps 224 and 230—step 224—List all user profiles gathered—step 226—start at the top of the Profile list go to step 240—step 230—list all locales or venues that are in conflict (provider may wish to place a limit on this, like top ten)—step 232—go to the top of the list—List all attractions or venues to be evaluated—step 236—total all premium flags—step 240—Compare profile with the OV value—step 242—does the profile and the attraction match? If yes go to step 243, if no go to step 244—step 243—begin, or add to, a temporary attraction list—step 244—does another profile need to be evaluated? Yes go to step 246, no go to step 248—step 246—go to the next profile on the user profile list and go to step 240—step 248—does another attraction need to be evaluated? yes go to step 250, no go to step 252—step 250—go to the next attraction on the attraction list and go to steps 226 and 234 concurrently—step 252—does another locale or venue need to be evaluated? yes go to step 254, no go to step 258—step 254—go to the next locale or venue to be evaluated—step 256—go to step 234—step 258—from the temporary attraction list generate a list with the most matches or close matches associated with the locales or venues—step 260—go to user completion process FIG. 1H step 282

FIG. 1H step 270—User completion process—step 272—this step is where the user/group profile is joined/compared to the Locale Database—step 274—are there multiple profiles/OV matches or are close matches? Yes go to step 276, no go to step 282—step 276—Will the Brute Force Method be used or will the defined delivery method be used? If Brute Force go to step 278, if Defined Method go to step 280—step 278—go to the brute force process FIG. 1G step 220—step 280—Order selections using the system defined method (alphabetically, 1^{st} matrix match, etc.)—step 282—Provide users with Locale selections—step 284—User selects destination locale—step 286—Were sub-groupings requested? If yes go to FIG. 1F step 180, if no go to step 288—step 288—Provide user with venue selections that best match the client profile—step 290—ask the user if they want venue tickets, either answer takes the user out of the profile process and brings them to the client tools page.

FIG. 1I Web Based Grouping Process—This process was developed as a way for a simplified, alternate, method for handing groupings of small family groups. Step 302—start of the Web Based Grouping Process—step 304—is this the 1^{s} name in the list? If yes go to step 306, if no go to step 310—step 306—Set the x=1—step 308—set profile priority to x—step 310—Is the Peering box checked? If yes go to step 312, if no go to step 314—step 312—set profile priority to x, go to step 318—step 314—increment x by 1—step 316—set profile priority to x—step 318—Is there another name? If yes go to step 304, if no go to step 320—step 320—Set constant M=x, set variable m=x—step 322—set x=1—step 324—Average all profiles with priority of x—step 326—Multiply Average profile by m—step 328—decrement m by 1—step 330—Does x=M? If yes go to step 334, if no go to step 332—step 332—increment x by 1 go to step 324—step 334—add the profiles 1 thru M—Divide the combined profiles using the formula M+(M−1)+(M−2)+ . . . +1—step 338—Provide the result to the User Completion Process step 270

### Locale/Venue/Product/Service Evaluation Process

FIG. 3A This is the process used to evaluate a venue, service or product—step 2—Develop matrices changes and/or multiples from the outside data (use of outside data is optional)—step 3—update outside database—step 4—Client develops internal standards for venue, product or service (VPS)—step 6—Will complex measurements be used? Yes to step 8, no go to step 10—step 8—go to process M FIG. 3B step 50—step 10—set variable m=0—step 12—List all venues at Locale—step 14—go to top of list—step 16—Increment m by 1—step 18—Assign weights to VPS according to standards—step 20 update Locale/VPS database—step 22—Are there more VPS at the locale? Yes go to step 24, no go to step 26—step 24—go to next VPS on list—step 26—total VPS premium flags—step 28—total VPS weights—step 30—divide the results from step 28 by m—step 32—update the Locale/VPS database—step 34—Is there another Locale/VPS to be rated? Yes go to step 6, no go to step 36—step 36—Evaluation complete exit process

FIG. 3B Process M step 50—This is the complex evaluation process. Using this process allows a VPS to be broken down into constituent parts and allows for the introduction of outside measures—step 52—Set variable v=0—step 54—List all VPS at the Locale—step 56—go to top of list—step 58—increment v by 1—step 60—List attractions at the VPS —step 62—set variables a, m and r to zero (0)—step 64—go to the top of the list—step 66—increment m by 1—step 68—Assign attraction weights according to standards—step 70—will outside standards be used? Yes go to step 72, no go to step 74—step 72—go to process D step 120 FIG. 3C—step 74—is this a multiple attraction venue, if yes go to step 76, if no go to step 88—step 76—update VPS/attraction database—step 78—are there more attractions for the VPS to be evaluated?, if yes go to step 66, if no go to step 80—step 80—Total attraction weights—step 82—was an outside standard multiple used? Yes go to step 84, no go to step 86—step 84—add variable (a from process D) to m—step 86—divide the results by m—step 88—will outside standards be used on to evaluate the venue? Yes go to step 90, no go to step 92—step 90—go to process D, step 120 FIG. 3C—step 92—update the Locale/VPS database—step 96—Are there more VPS? If yes go to step 98, if no go to step 102—step 98—set variable a=0—step 100—go to next VPS on list, go to step 58—step 102—total VPS weights—step 104—divide the venue weights by v—step 106—Will outside standards be used to evaluate the Locale? It yes go to step 108, if no go to step 110—step 108—go to process D step 140 FIG. 3C—step 110—go to step 32 FIG. 3A.

FIG. 3C Process D. step 120, This is the outside measurements process. We can handle 2 types of outside measurements processes with this. Either a multiple can be assigned to multiply against the weights of the VPS matrix, or the VPS matrix values can be changed—step 122—will the multiple method or the matrix substitution method be used? If multiple go to step 124, if matrix go to step 134—step 124—Is there a recognized outside standard for the VPS or attraction? Yes go to step 128, no go to step 126—step 126—default multiple M is set to 1—step 128—set M per defined standards—step 130—multiply the assigned weights by M—step 132—add M to variable (a=a+M), set variable r to M (r=M)—step 134—get matrix changes from the outside database from step 3 FIG. 3A—step 136—make changes to matrix weights per database—step 138—set premium flag for the Attraction, Venue or Locale—step 140—was the original process call from step 70, 90 or 106? If 70 go to step 142, if 90 go to step 144, and if from 106 go to step 148—step 142—go to step 74 FIG. 3B—step 144—go to step 92 FIG. 3 B—step 148—go to step 32 FIG. 3A

TABLE 1
A demonstration rating system:

| | | | | | | | | | | | | | | | | | | | | | | | |
|---|---|---|---|---|---|---|---|---|---|---|---|---|---|---|---|---|---|---|---|---|---|---|---|
| Sports | Professional | AS | 7 | YO | 5 | TN | 3 | PO | 5 | AP | 6 | SA | 5 | HS | 6 | SH | 6 | XF | 2 | RA | 8 | DA | .5 |
| | College | AS | 7 | YO | 5 | TN | 3 | PO | 5 | AP | 6 | SA | 5 | HS | 6 | SH | 6 | XF | 2 | RA | 7 | DA | .5 |
| | Recreational | AS | 7 | YO | 4 | TN | 6 | PO | 8 | AP | 6 | SA | 5 | HS | 7 | SH | 6 | XF | 2 | RA | 6 | DA | 1.0 |
| | Boating | AS | 7 | YO | 4 | TN | 6 | PO | 8 | AP | 6 | SA | 5 | HS | 7 | SH | 6 | XF | 2 | RA | 5 | DA | 1.0 |
| | Hiking trails | AS | 7 | YO | 4 | TN | 6 | PO | 8 | AP | 6 | SA | 5 | HS | 7 | SH | 6 | XF | 2 | RA | 4 | DA | 1.0 |
| | Soccer fields | AS | 7 | YO | 4 | TN | 6 | PO | 8 | AP | 6 | SA | 5 | HS | 7 | SH | 6 | XF | 2 | RA | 3 | DA | 1.0 |
| | Baseball field | AS | 7 | YO | 4 | TN | 6 | PO | 8 | AP | 6 | SA | 5 | HS | 7 | SH | 6 | XF | 2 | RA | 2 | DA | 1.0 |
| | Biking trails | AS | 7 | YO | 4 | TN | 6 | PO | 8 | AP | 6 | SA | 5 | HS | 7 | SH | 6 | XF | 2 | RA | 3 | DA | 1.0 |
| | etc. . . | | | | | | | | | | | | | | | | | | | | | | |
| Concerts | Classic | AS | 3 | YO | 7 | TN | 3 | PO | 3 | AP | 3 | SA | 2 | HS | 2 | SH | 5 | XF | 2 | RA | 2 | DA | .2 |
| | Pop | AS | 6 | YO | 4 | TN | 3 | PO | 7 | AP | 6 | SA | 3 | HS | 4 | SH | 5 | XF | 3 | RA | 2 | DA | .2 |
| | Rock | AS | 5 | YO | 6 | TN | 3 | PO | 6 | AP | 5 | SA | 3 | HS | 4 | SH | 5 | XF | 3 | RA | 2 | DA | .2 |
| Movies | | AS | 7 | YO | 6 | TN | 7 | PO | 8 | AP | 6 | SA | 5 | HS | 3 | SH | 5 | XF | 5 | RA | 3 | DA | 1.0 |
| Theater | | AS | 7 | YO | 6 | TN | 7 | PO | 8 | AP | 6 | SA | 5 | HS | 3 | SH | 5 | XF | 5 | RA | 2 | DA | 1.0 |
| Amusement Parks | Standard | AS | 9 | YO | 7 | TN | 7 | PO | 8 | AP | 8 | SA | 5 | HS | 7 | SH | 7 | XF | 3 | RA | 6 | DA | 1.0 |
| | Water | AS | 9 | YO | 8 | TN | 8 | PO | 9 | AP | 8 | SA | 5 | HS | 7 | SH | 7 | XF | 3 | RA | 6 | DA | 1.0 |
| | Themed | AS | 8 | YO | 5 | TN | 7 | PO | 8 | AP | 8 | SA | 5 | HS | 7 | SH | 7 | XF | 3 | RA | 6 | DA | 1.0 |
| | Carnivals | AS | 6 | YO | 5 | TN | 7 | PO | 7 | AP | 7 | SA | 5 | HS | 6 | SH | 6 | XF | 2 | RA | 5 | DA | .1 |
| Dining | 5 Star | AS | 2 | YO | 6 | TN | 9 | PO | 8 | AP | 2 | SA | 7 | HS | 8 | SH | 5 | XF | 8 | RA | 2 | DA | 1.0 |
| | 4 Star | AS | 5 | YO | 5 | TN | 8 | PO | 7 | AP | 2 | SA | 6 | HS | 8 | SH | 5 | XF | 7 | RA | 2 | DA | 1.0 |
| | Themed | AS | 7 | YO | 6 | TN | 6 | PO | 8 | AP | 6 | SA | 5 | HS | 8 | SH | 5 | XF | 8 | RA | 2 | DA | 1.0 |
| Shopping | Clothing | AS | 7 | YO | 4 | TN | 7 | PO | 8 | AP | 7 | SA | 5 | HS | 3 | SH | 5 | XF | 5 | RA | 5 | DA | 1.0 |
| | Furniture | AS | 7 | YO | 7 | TN | 5 | PO | 8 | AP | 6 | SA | 5 | HS | 3 | SH | 5 | XF | 3 | RA | 2 | DA | 1.0 |
| | Knick-knacks | AS | 7 | YO | 5 | TN | 4 | PO | 8 | AP | 6 | SA | 3 | HS | 3 | SH | 5 | XF | 3 | RA | 1 | DA | 1.0 |
| Cultural | Museums | AS | 3 | YO | 5 | TN | 3 | PO | 4 | AP | 2 | SA | 2 | HS | 1 | SH | 5 | XF | 5 | RA | 2 | DA | 1.0 |
| | Classic | AS | 6 | YO | 6 | TN | 3 | PO | 5 | AP | 2 | SA | 3 | HS | 4 | SH | 5 | XF | 2 | RA | 2 | DA | 1.0 |
| | Down Towns | | | | | | | | | | | | | | | | | | | | | | |
| | Themed | AS | 5 | YO | 6 | TN | 3 | PO | 5 | AP | 2 | SA | 3 | HS | 3 | SH | 5 | XF | 2 | RA | 2 | DA | 1.0 |
| | Down Towns | | | | | | | | | | | | | | | | | | | | | | |
| | Fair | AS | 6 | YO | 4 | TN | 3 | PO | 6 | AP | 2 | SA | 4 | HS | 4 | SH | 6 | XF | 2 | RA | 2 | DA | .1 |
| | Zoos | AS | 6 | YO | 5 | TN | 3 | PO | 5 | AP | 2 | SA | 7 | HS | 3 | SH | 5 | XF | 2 | RA | 2 | DA | 1.0 |
| Parks | Federal | AS | 6 | YO | 5 | TN | 6 | PO | 7 | AP | 5 | SA | 6 | HS | 6 | SH | 5 | XF | 6 | RA | 4 | DA | 1.0 |
| | State | AS | 6 | YO | 5 | TN | 6 | PO | 7 | AP | 5 | SA | 6 | HS | 6 | SH | 5 | XF | 6 | RA | 4 | DA | 1.0 |
| | Local | AS | 6 | YO | 5 | TN | 6 | PO | 7 | AP | 5 | SA | 6 | HS | 6 | SH | 5 | XF | 6 | RA | 3 | DA | 1.0 |
| | Lake | AS | 6 | YO | 4 | TN | 7 | PO | 8 | AP | 6 | SA | 5 | HS | 6 | SH | 5 | XF | 7 | RA | 4 | DA | 1.0 |
| | Trails | AS | 8 | YO | 4 | TN | 7 | PO | 9 | AP | 6 | SA | 5 | HS | 6 | SH | 5 | XF | 5 | RA | 3 | DA | 1.0 |

TABLE 2
Town A has the following Simple System
Sports
Recreational

| | | | | | | | | | | | | | | | | | | | | | | |
|---|---|---|---|---|---|---|---|---|---|---|---|---|---|---|---|---|---|---|---|---|---|---|
| Boating | AS | 7 | YO | 4 | TN | 6 | PO | 8 | AP | 6 | SA | 5 | HS | 7 | SH | 6 | XF | 2 | RA | 5 | DA | 1.0 |
| Hiking trails 3 | AS | 7 | YO | 4 | TN | 6 | PO | 8 | AP | 6 | SA | 5 | HS | 7 | SH | 6 | XF | 2 | RA | 4 | DA | 1.0 |
| Soccer fields 4 | AS | 7 | YO | 4 | TN | 6 | PO | 8 | AP | 6 | SA | 5 | HS | 7 | SH | 6 | XF | 2 | RA | 3 | DA | 1.0 |
| Baseball field 2 | AS | 7 | YO | 4 | TN | 6 | PO | 8 | AP | 6 | SA | 5 | HS | 7 | SH | 6 | XF | 2 | RA | 2 | DA | 1.0 |
| Biking trails 8 | AS | 7 | YO | 4 | TN | 6 | PO | 8 | AP | 6 | SA | 5 | HS | 7 | SH | 6 | XF | 2 | RA | 3 | DA | 1.0 |

Concerts

| | | | | | | | | | | | | | | | | | | | | | | |
|---|---|---|---|---|---|---|---|---|---|---|---|---|---|---|---|---|---|---|---|---|---|---|
| 2 Classic | AS | 3 | YO | 7 | TN | 3 | PO | 3 | AP | 3 | SA | 2 | HS | 2 | SH | 5 | XF | 2 | RA | 2 | DA | .2 |
| 2 Pop | AS | 6 | YO | 4 | TN | 3 | PO | 7 | AP | 6 | SA | 3 | HS | 4 | SH | 5 | XF | 3 | RA | 2 | DA | .2 |
| 1 Rock | AS | 5 | YO | 6 | TN | 3 | PO | 6 | AP | 5 | SA | 3 | HS | 4 | SH | 5 | XF | 3 | RA | 2 | DA | .2 |

Movies

| | | | | | | | | | | | | | | | | | | | | | | |
|---|---|---|---|---|---|---|---|---|---|---|---|---|---|---|---|---|---|---|---|---|---|---|
| 4 screens | AS | 7 | YO | 6 | TN | 7 | PO | 8 | AP | 6 | SA | 5 | HS | 3 | SH | 5 | XF | 5 | RA | 3 | DA | 1.0 |

Amusement Parks

| | | | | | | | | | | | | | | | | | | | | | | |
|---|---|---|---|---|---|---|---|---|---|---|---|---|---|---|---|---|---|---|---|---|---|---|
| 1 Water | AS | 9 | YO | 8 | TN | 8 | PO | 9 | AP | 8 | SA | 5 | HS | 7 | SH | 7 | XF | 3 | RA | 6 | DA | 1.0 |
| 1 Carnivals | AS | 6 | YO | 5 | TN | 7 | PO | 7 | AP | 7 | SA | 5 | HS | 6 | SH | 6 | XF | 2 | RA | 5 | DA | .1 |

Dining

| | | | | | | | | | | | | | | | | | | | | | | |
|---|---|---|---|---|---|---|---|---|---|---|---|---|---|---|---|---|---|---|---|---|---|---|
| 1 5 Star | AS | 2 | YO | 6 | TN | 9 | PO | 8 | AP | 2 | SA | 7 | HS | 8 | SH | 5 | XF | 8 | RA | 2 | DA | 1.0 |
| 3 4 Star | AS | 5 | YO | 5 | TN | 8 | PO | 7 | AP | 2 | SA | 6 | HS | 8 | SH | 5 | XF | 7 | RA | 2 | DA | 1.0 |

Shopping

| | | | | | | | | | | | | | | | | | | | | | | |
|---|---|---|---|---|---|---|---|---|---|---|---|---|---|---|---|---|---|---|---|---|---|---|
| 5 Clothing | AS | 7 | YO | 4 | TN | 7 | PO | 8 | AP | 7 | SA | 5 | HS | 3 | SH | 5 | XF | 5 | RA | 5 | DA | 1.0 |
| 3 Furniture | AS | 7 | YO | 7 | TN | 5 | PO | 8 | AP | 6 | SA | 5 | HS | 3 | SH | 5 | XF | 3 | RA | 2 | DA | 1.0 |
| 6 Knick- | AS | 7 | YO | 5 | TN | 4 | PO | 8 | AP | 6 | SA | 3 | HS | 3 | SH | 5 | XF | 3 | RA | 1 | DA | 1.0 |
| knacks | | | | | | | | | | | | | | | | | | | | | | |

Cultural

| | | | | | | | | | | | | | | | | | | | | | | |
|---|---|---|---|---|---|---|---|---|---|---|---|---|---|---|---|---|---|---|---|---|---|---|
| 2 Museums | AS | 3 | YO | 5 | TN | 3 | PO | 4 | AP | 2 | SA | 2 | HS | 1 | SH | 5 | XF | 5 | RA | 2 | DA | 1.0 |
| 1 Themed | AS | 5 | YO | 6 | TN | 3 | PO | 5 | AP | 2 | SA | 3 | HS | 3 | SH | 5 | XF | 2 | RA | 2 | DA | 1.0 |
| Down | | | | | | | | | | | | | | | | | | | | | | |
| Towns | | | | | | | | | | | | | | | | | | | | | | |
| 1 Fair | AS | 6 | YO | 4 | TN | 3 | PO | 6 | AP | 2 | SA | 4 | HS | 4 | SH | 6 | XF | 2 | RA | 2 | DA | 1.0 |
| 1 Zoos | AS | 6 | YO | 5 | TN | 3 | PO | 5 | AP | 2 | SA | 7 | HS | 3 | SH | 5 | XF | 2 | RA | 2 | DA | 1.0 |

Parks

| | | | | | | | | | | | | | | | | | | | | | | |
|---|---|---|---|---|---|---|---|---|---|---|---|---|---|---|---|---|---|---|---|---|---|---|
| 1 Federal | AS | 6 | YO | 5 | TN | 6 | PO | 7 | AP | 5 | SA | 6 | HS | 6 | SH | 5 | XF | 6 | RA | 4 | DA | 1.0 |
| 1 State | AS | 6 | YO | 5 | TN | 6 | PO | 7 | AP | 5 | SA | 6 | HS | 6 | SH | 5 | XF | 6 | RA | 4 | DA | 1.0 |
| 3 Local | AS | 6 | YO | 5 | TN | 6 | PO | 7 | AP | 5 | SA | 6 | HS | 6 | SH | 5 | XF | 6 | RA | 3 | DA | 1.0 |
| 1 Lake | AS | 6 | YO | 4 | TN | 7 | PO | 8 | AP | 6 | SA | 5 | HS | 6 | SH | 5 | XF | 7 | RA | 4 | DA | 1.0 |
| 3 Trails | AS | 8 | YO | 4 | TN | 7 | PO | 9 | AP | 6 | SA | 5 | HS | 6 | SH | 5 | XF | 5 | RA | 3 | DA | 1.0 |
| Totals | AS | 390 | YO | 295 | TN | 346 | PO | 453 | AP | 326 | SA | 284 | HS | 307 | SH | 327 | XF | 223 | RA | 175 | | |
| Total | | | | | | | | | | | | | | | | | | | | | | |
| venues 61 | | | | | | | | | | | | | | | | | | | | | | |
| Local OV | AS | 6.4 | YO | 4.8 | TN | 5.7 | PO | 7.4 | AP | 5.3 | SA | 4.6 | HS | 5.0 | SH | 5.4 | XF | 3.7 | RA | 2.9 | | |
| Profile average | | | | | | | | | | | | | | | | | | | | | | |

1. A computer-aided decision-making system, comprising: a rules-based analysis engine capable of creating dynamic rule sets, said rules being used for selecting and scoring and ranking several choices; a user interface operable to accept user-provided information and selections and responses to system inquiries, said user interface to generate a consumer profile or profiles and a set of proposals and feedback, said user interface comprising a multiple selection that is selectable by a user for assisting in a single choice and controlled by said rules-based analysis engine to aid the user in making a single, or multiple, choice/s, said advocates being abstract personalities embodied in software and representing points of view with respect to a decision to be made on the choice/s, said points of view including relatively stronger positions on some issues and relatively weaker positions on other issues; and wherein said rules-based analysis engine accepts said user-provided information and presents through said user interface choices to aid the user in making a decision, said choices being at least one of commented on and chosen by said software.

2. The system of claim 1, wherein said rules-based analysis engine includes several databases, said databases comprising: a merchant products/services/venue database containing detailed product, service, or venue information; and a user profile database containing individual or group profile information pertaining to personal characteristics, desires and behavior and/or product/service/venue preferences.

3. The system of claim 2, wherein said rules-based analysis engine comprises: a residual knowledge database for maintaining data and modifications to information contained in said merchant products/services/venues database; and a user decision document database capable of storing decision state information responsive to the user requesting to store a current decision state for later use.

4. The system of claim 2, wherein said rules-based analysis engine further comprises: multiple database descriptions for indexing of information contained in said databases; multiple system rules/facts that are applicable to multiple decision domains; and multiple application rules/facts that are specific to a particular decision domain.

5. A computer-aided decision making system, comprising of: a web browser; a server-side application/web server, wherein said web browser and said server-side application/web server form a distributed computing client-server system; multiple applets for running a rules-based analysis engine, rules of said rules-based analysis engine being used for selecting scoring and ranking multiple choices presented by said client-server system, said scoring and ranking retaining all the choices without removal of lower ranking choices; and an interface for displaying system-made offers.

6. A computer implemented method for assisting a person in making a decision, comprising: decomposing a choice from a single profile or multiple profiles, wherein said subchoices represent different dimensions of a decision space; determining a plurality of potential proposals for each said subchoice; ranking said subchoices according to a range of general to specific subchoices and presenting said ranking to a user for random access at any position along the general to specific ranking; ranking said plurality of potential proposals in accordance with a user's selection among said plurality of subchoices; ordering said proposals using presentation to indicate a relative ranking of said proposals; presenting all of said plurality of proposals in ranking order to the user without removing proposals from said plurality of proposals; and accepting a selection by the user of any proposal of said plurality of proposals regardless of a position of a chosen proposal in said ranking order.

7. A system to quantify the concepts of “Fun, Risk, etc.” as it pertains to the product, service or venue. We recognize that these human terms that were immeasurable by a computer earlier are really made up of a complex structure of other measurable, or deterministic human concepts or “Feelings.” Thus a concepts such as “Fun” is made up of a matrix of other terms that can be determined/defined numerically. This creates a value called the “Objective Value.” Objective value is defined as a set of values for “Fun or Risk or many other user defined but formerly none quantifiable human value,” based on several standard factors. This Objective Value (OV) is then utilized to determine specific venue choices for an individual or for a set of individuals using the decision engine mentioned in claim 1.

8. Utilizing system of claim 7, the OV, one can start to rank choices based on their OV. Clients can utilize the personal or group rankings to assist in determining the preferred choice for the subset presented to the user by the system. An example would be that City Planners can then utilize the tool to better select what venues or services would be best suited for their city as the selection of a particular venue could change the OV of their city; Real Estate firms could start to change their offerings offered to their clients based on their clients OV, thus creating an Automated Real Estate Agent that is more powerful than the ones used today; On-line Travel Booking services could create Automated Travel Agents based on their client's OV, etc.

9. The system of claim 2 that allows for the input of outside value systems into the decision matrix.

10. The system of claim 6 that allows for the incorporation of individual, groups or organizations to be evaluated and acted upon for specific decisions or value judgments.

11. The system allows for the possibility of “Reverse” data mining. The current system follows a specific production path. This starts at the individual purchasing databases, to the company to the good, product or service. The current focus of data mining is to evaluate the individual purchasing database to predict future trends or purchases of a company's products, services or venue. Reverse data mining allows for the evaluation of the product, service or venue for comparison with a client's actual desires, wants or needs. This reduces the costs required to be expended with the credit companies and opens up the actual population that can be serviced.
